(19) United States
(12) Patent Application Publication
(10) Pub. No.: US 2026/0061603 A1
(43) Pub. Date: Mar. 5, 2026

(54) CHEMICAL CONTAINER REPLACEMENT SYSTEM

(71) Applicant: Samsung Electronics Co., Ltd., Suwon-si (KR)

(72) Inventors: Pyungkang KIM, Suwon-si (KR); Jongseong KO, Suwon-si (KR); Jungjun PARK, Suwon-si (KR); Donghyun KIM, Suwon-si (KR); Yongmin CHO, Suwon-si (KR); Junhyeok PARK, Suwon-si (KR); Jungjoon PARK, Suwon-si (KR); Yongjun SEO, Suwon-si (KR); Kongwoo LEE, Suwon-si (KR); Daeyong KIM, Suwon-si (KR); Minjae LEE, Suwon-si (KR); Hyunyoung LEE, Suwon-si (KR); Sungmin CHO, Suwon-si (KR); Hyunwoong CHOI, Suwon-si (KR)

(73) Assignee: Samsung Electronics Co., Ltd., Suwon-si (KR)

(21) Appl. No.: 19/276,212

(22) Filed: Jul. 22, 2025

(30) Foreign Application Priority Data
Sep. 2, 2024 (KR) 10-2024-0118807
Jan. 6, 2025 (KR) 10-2025-0001828

(51) Int. Cl. B25J 9/16; B25J 5/00; B25J 9/00; B25J 15/00; B25J 19/04

(52) U.S. Cl. CPC B25J 9/162; B25J 5/007; B25J 9/0087; B25J 15/0019; B25J 19/04

(57) ABSTRACT

A replacement robot includes a robot body, a robot arm on the robot body, an equipment cap gripper on the robot arm and configured to open and close an equipment cap module connected to a chemical container, the chemical container being an empty container, and a container table on the robot body. The container table includes a table body, a first container case on the table body and configured to accommodate an empty container, a second container case on the table body and configured to accommodate a full container, and a case driving device configured to rotate the first container case toward the second container case.

### CROSS-REFERENCE TO RELATED APPLICATIONS

This U.S. non-application claims priority under 35 U.S.C. § 119 to Korean Patent Application Nos. 10-2024-0118807, filed on Sep. 2, 2024, and 10-2025-0001828, filed on Jan. 6, 2025, in the Korean Intellectual Property Office, the disclosures of which are incorporated by reference herein in their entireties.

### BACKGROUND

Example embodiments are directed to a chemical container replacement system for automatically replacing a chemical container stored in semiconductor equipment.

Chemicals are used in various types of semiconductor manufacturing equipment. The semiconductor manufacturing equipment may receive a chemical container from the outside and may store the chemical container in a cabinet device included in the semiconductor manufacturing equipment. When contents of the chemical container are depleted, an operator may replace the empty chemical container stored in the cabinet device with a full chemical container.

However, some chemicals used in the semiconductor manufacturing equipment include toxic material. When the chemical container is damaged during the operation of replacing the chemical container, the operator may be exposed to the dangerous and/or hazardous toxic material. Therefore, a system that may automatically perform the operation of replacing the chemical container is beneficial.

### SUMMARY

Example embodiments provide a chemical container replacement system for automatically supplying a chemical container filled with contents to semiconductor manufacturing equipment.

Example embodiments provide also provide a chemical container replacement system for automatically removing an empty chemical container from a FAB.

However, example embodiments are not limited thereto, and other example embodiments may be clearly understood from the following description by those skilled in the art.

According to some example embodiments of the inventive concepts, a replacement robot includes a robot body, a robot arm on the robot body, an equipment cap gripper on the robot arm and configured to open and close an equipment cap module connected to a chemical container, the chemical container being an empty container, and a container table on the robot body. The container table includes a table body, a first container case on the table body and configured to accommodate the empty container, a second container case on the table body and configured to accommodate a full container, and a case driving device configured to rotate the first container case toward the second container case.

According to some example embodiments of the inventive concepts, a replacement robot includes a robot body, a communication interface configured to communicate with an external cabinet device, a robot arm on the robot body, and a container table on the robot body, wherein the container table includes a table body, a first container case on the table body and configured to accommodate an empty container, a second container case on the table body and configured to accommodate a full container, and a case driving device configured to rotate the first container case toward the second container case.

According to some example embodiments of the inventive concepts, a replacement robot includes a robot body, a communication interface configured to communicate with an external device, a traveling unit configured to drive the robot body, a container table on the robot body, and a control unit. The container table includes a table body, a first container case on the table body and configured to accommodate an empty container, a second container case on the table body and configured to accommodate a full container, and a case driving device configured to rotate the first container case toward the second container case. The control unit is configured to receive, via the communication interface, a chemical container replacement command, and control, based on the chemical container replacement command, the traveling unit to move the robot body toward a chemical equipment.

According to some example embodiments of the inventive concepts, a cabinet device includes a cabinet body, a cabinet loading unit on the cabinet body and configured to load a chemical container, and a cabinet driving device on the cabinet body and configured to drive the cabinet body between the inside and the outside of chemical equipment in a first horizontal direction. The cabinet driving device includes an equipment pinion connected to an equipment rack fixed to the chemical equipment, a cabinet rack extending in the first horizontal direction and fixed to the cabinet body, a cabinet gear module connected to the equipment pinion and the cabinet rack, a sliding member connected to the cabinet gear module and configured to be driven in a direction opposite to the driving direction of the cabinet body, a sliding guide fixed to the cabinet body and configured to guide the operation of the sliding member, and a cabinet driving module configured to rotate the equipment pinion.

According to some example embodiments of the inventive concept, a cabinet device includes a cabinet body, a cabinet loading unit mounted on the cabinet body and configured to load a chemical container, and a cabinet driving device on a lower portion of the cabinet body and configured to drive the cabinet body in a first horizontal direction between the inside and the outside of chemical equipment. The cabinet driving device includes a frame placed between a bottom surface of the cabinet body and a bottom surface of the chemical equipment, a first pinion inside the frame, a first upper rack and a second upper rack inside a top surface of the frame, an intermediate structure in a bottom surface of the frame and including a first lower rack and a second pinion, and a cabinet driving module configured to rotate the first pinion. The first pinion is configured to mesh with the first upper rack and the first lower rack, and the second pinion is configured to mesh with the second upper rack and the second lower rack fixed to the bottom surface of the chemical equipment.

According to some example embodiments, a method of operating a replacement robot includes receiving a container replacement command via a control unit of the replacement robot, controlling a traveling unit of the replacement robot to move the replacement robot towards a chemical equipment, transmitting an open command to the chemical equipment using the replacement robot, replacing, using the replacement robot, an empty container in the chemical equipment with a full container, and transmitting a close command to the chemical equipment when the empty container is replaced. According to some example embodiments, transmitting the open command to the chemical equipment using the replacement robot includes transmitting the open command to a cabinet device of the chemical equipment to open the cabinet device. According to some example embodiments, replacing the empty container includes controlling an equipment cap gripper on a robot arm of the replacement robot to separate a cap connected to an upper inlet of the empty container, and controlling the robot arm to lift the cap from the empty container. According to some example embodiments, the equipment cap gripper is configured to open and close an equipment cap module connected to empty container, and the equipment cap module includes the cap connected to the upper inlet of the empty container and a tube connected to a bottom of the cap and inserted into the empty container, and the method further includes controlling the robot arm to lift the cap while maintaining an alignment state of the tube and the upper inlet of the empty container such that a base end of the tube exposed above the empty container overlaps with the upper inlet of the empty container in a vertical direction. According to some example embodiments, obtaining, using at least one camera on the replacement robot, an alignment image of the tube and the empty container, identifying, based on the alignment image, a position error between the tube and the upper inlet of the empty container, and controlling the robot arm to correct the position error.

### BRIEF DESCRIPTION OF THE DRAWINGS

Example embodiments will be more clearly understood from the following detailed description taken in conjunction with the accompanying drawings in which:

FIG. 1 is a perspective view of a chemical container replacement system, according to some example embodiments.

FIG. 2 is a perspective view of a replacement robot, according to some example embodiments.

FIG. 3 is a perspective view of a container table, according to some example embodiments.

FIG. 4 is a perspective view of a container case, according to some example embodiments.

FIGS. 5A, 5B, and 5C are diagrams illustrating an operation of the container case, according to some example embodiments.

FIGS. 6A, 6B, 6C, 6D, and 6E are diagrams illustrating an operation of a container case, according to some example embodiments.

FIG. 7 is a diagram illustrating an operation of the container table, according to some example embodiments.

FIG. 8 is a diagram illustrating an operation of another container table, according to some example embodiments.

FIG. 9 is a diagram illustrating a method of detecting whether a container is accommodated in the container case, according to some example embodiments.

FIG. 10 is a diagram illustrating a method of detecting whether the container is accommodated in the container case, according to some example embodiments.

FIG. 11 is a perspective view of a container gripper, according to some example embodiments.

FIG. 12 is a perspective view of an equipment cap gripper, according to some example embodiments.

FIG. 13 is a perspective view of a return cap gripper, according to some example embodiments.

FIG. 14 is a perspective view of a door gripper, according to some example embodiments.

FIGS. 15A, 15B, 15C, 15D, and 15E are diagrams illustrating an operation of separating a cap by the equipment cap gripper, according to some example embodiments.

FIGS. 16A, 16B, 16C, 16D, 16E, and 16F are diagrams illustrating an operation of replacing the chemical container by the replacement robot, according to some example embodiments.

FIG. 17 is a perspective view illustrating the operation of replacing the chemical container by the replacement robot, according to some example embodiments.

FIG. 18 is a diagram illustrating an operation of correcting a position error by the replacement robot, according to some example embodiments.

FIG. 19 is a diagram illustrating an operation of delivering the chemical container by the replacement robot and a return robot, according to some example embodiments.

FIG. 20 is a diagram illustrating an operation of replacing the chemical container by the replacement robot and a cabinet device, according to some example embodiments.

FIGS. 21A and 21B are perspective views of the cabinet device, according to some example embodiments.

FIG. 22 is a perspective view of a cabinet driving device, according to some example embodiments.

FIGS. 23A and 23B are perspective views of the cabinet device, according to some example embodiments.

FIGS. 24A and 24B are perspective views of another cabinet driving device, according to some example embodiments.

FIGS. 25A and 25B are perspective views of the other cabinet driving device, according to some example embodiments.

FIG. 26 is a perspective view of the cabinet device, according to some example embodiments.

FIG. 27 is a perspective view of a door handle and a marker, according to some example embodiments.

### DETAILED DESCRIPTION OF EXAMPLE EMBODIMENTS

Hereinafter, example embodiments are described in detail with reference to the accompanying drawings. The same reference numerals are used for the same components on the drawings and redundant description thereof is omitted.

Hereinafter, example embodiments are described clearly and in detail to the extent that a person skilled in the art may easily practice the inventive concept.

Herein, an element described as being “spaced apart” from another element and/or an element described as being “separated” from another element in a particular direction (e.g., in a vertical direction or a horizontal direction) may be understood as being isolated from direct contact with another element in the particular direction (e.g., being isolated from direct contact with another element in the vertical direction or being isolated from direct contact with another element in the horizontal direction). Similarly, elements described as being “spaced apart” from one another in the particular direction (e.g., in the vertical direction or the horizontal direction) and/or elements described as being “separated” from one another may be understood as being isolated from direct contact with one another in the particular direction (e.g., in the vertical direction or the horizontal direction). Similarly, a structure herein positioned between two other structures to separate the two other structures from each other may be understood to be configured to isolate the two other structures from direct contact with each other.

When the terms “about” or “substantially” are used in this specification in connection with a numerical value, it is intended that the associated numerical value includes a manufacturing or operational tolerance (e.g., ±10%) around the stated numerical value. Moreover, when the words “about” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes. When ranges are specified, the range includes all values therebetween such as increments of 0.1%.

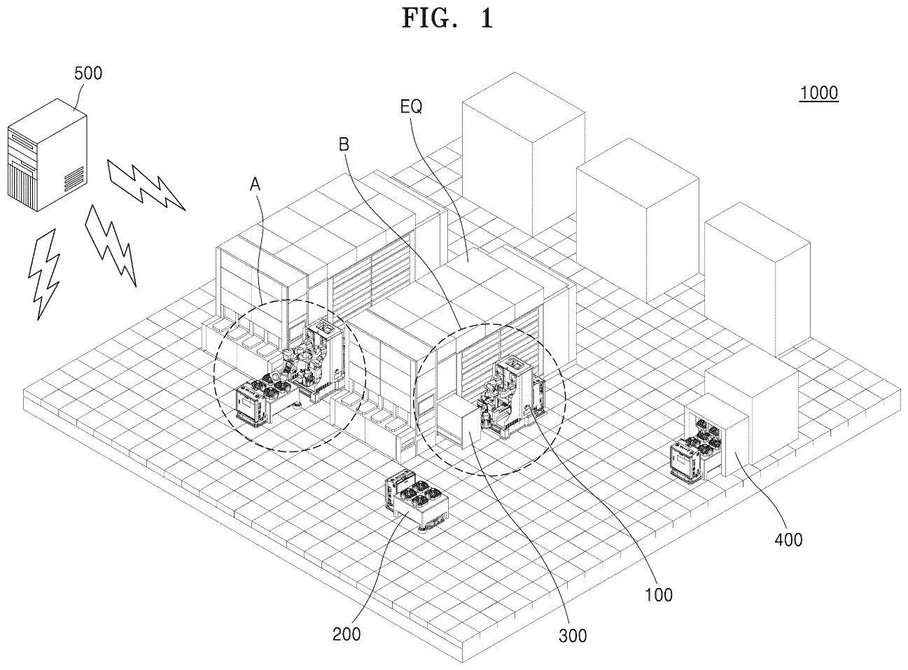

FIG. 1 is a perspective view of a chemical container replacement system 1000 according to some example embodiments.

Referring to FIG. 1, the chemical container replacement system 1000 may include a replacement robot 100, a return robot 200, a cabinet device 300, a container port 400, and a server 500.

Chemical equipment EQ may include semiconductor manufacturing equipment that performs a semiconductor manufacturing process using chemicals. As an example, the chemical equipment EQ may include one piece of equipment that performs a photolithography process. In some example embodiments, the chemical equipment EQ may store a photoresist (PR) bottle and may perform a photolithography process using PR included in the PR bottle.

The replacement robot 100 may replace an empty container EC stored in the cabinet device 300 with a full container FC. Herein, the “empty container EC” may refer to a chemical container CC where contents are exhausted. The “empty container EC” may include a chemical container CC where contents are completely exhausted or a chemical container CC containing only a small amount of contents (e.g., 0.01% to 5% of the total amount) relative to the total amount of the chemical container CC. The “empty container EC” may be replaced with various names, such as “chemical container to be replaced”, “chemical container requiring replacement”, or “used chemical container”but is collectively referred to as “empty container EC”herein.

In addition, the “full container FC” may refer to a chemical container CC filled with contents. The “full container FC” may include a chemical container CC that is completely filled with contents or a chemical container CC containing a similar amount of contents to the total capacity of the chemical container CC (e.g., 80% or more of the total amount). The “full container FC” may be replaced with various names, such as “replacement chemical container”, “new container”, or “newly provided container”, but is collectively referred to as “full container FC”herein.

The return robot 200 may transfer the chemical container CC between the container port 400 and the replacement robot 100. The return robot 200 may receive the full container FC from the container port 400. The return robot 200 may load the full container FC and travel from the container port 400 toward the replacement robot 100. The return robot 200 may provide the full container FC to the replacement robot 100.

Conversely, the return robot 200 may receive the empty container EC from the replacement robot 100. The return robot 200 may load the empty container EC provided from the replacement robot 100 and may travel from the replacement robot 100 toward the container port 400. The return robot 200 may provide the empty container EC to the container port 400.

Although FIG. 1 only shows that the chemical container replacement system 1000 includes the return robot 200, this is merely an example. The chemical container replacement system 1000 may not include the return robot 200. In some example embodiments, the replacement robot 100 may function as the return robot 200. The replacement robot 100 may reciprocate (or travel between) between the cabinet device 300 and the container port 400. The replacement robot 100 may receive the full container FC from the container port 400 and may provide the empty container EC to the container port 400. In addition, the replacement robot 100 may receive the empty container EC from the cabinet device 300 and may provide the full container FC to the cabinet device 300.

The cabinet device 300 may be arranged inside the chemical equipment EQ. The cabinet device 300 may store or load at least one chemical container CC. The chemical container CC loaded into the cabinet device 300 may be connected to an equipment cap module connected to the chemical equipment EQ. The cabinet device 300 may be driven in the horizontal direction between the inside and the outside of the chemical equipment EQ. The cabinet device 300 may be exposed to the outside of the chemical equipment EQ in an “open state” and may enter the inside of the chemical equipment EQ in a “closed state”.

The “open state of the cabinet device 300” or an “open state of a cabinet body” may refer to “a state where the cabinet device 300 or the cabinet body is exposed to the outside of the chemical equipment EQ” for replacing the chemical container CC. In addition, the “closed state of the cabinet device 300” or a “closed state of the cabinet body” may refer to a state where the cabinet device 300 or the cabinet body enters the inside of the chemical equipment EQ.

The container port 400 may receive the full container FC from the outside of a FAB and may discharge the empty container EC to the outside of the FAB. The FAB may refer to a semiconductor fabrication plant. The container port 400 may remove incoming particles from the outside of the FAB.

The server 500 may transmit various types of signals to the replacement robot 100, the return robot 200, the cabinet device 300, the container port 400, and the chemical equipment EQ or may receive various types of signals from the replacement robot 100, the return robot 200, the cabinet device 300, the container port 400, and the chemical equipment EQ. For example, the server 500 may transmit various types of commands or receive various types of requests.

According to some example embodiments, the server 500 may receive a chemical container replacement request from the cabinet device 300 or the chemical equipment EQ. The chemical container replacement request may include a signal to replace the empty container EC stored in the cabinet device 300 with the full container FC. When the chemical container replacement request is received, the server 500 may transmit a chemical container supply command to the container port 400 and may issue a chemical container transfer command to the return robot 200. The chemical container supply command may include a signal to supply the full container FC to the inside of the FAB, and the chemical container transfer command may include a signal to receive the full container FC from the container port 400 and move to the replacement robot 100 while loading the full container FC received from the container port 400. The return robot 200 and the container port 400 may each receive the respective command as described above and perform an operation corresponding to the command.

According to some example embodiments, the server 500 may receive an equipment arrival signal from the return robot 200. The equipment arrival signal may include a signal indicating that the return robot 200 has arrived at a position adjacent to the chemical equipment EQ where replacement of the chemical container CC is required. When the equipment arrival signal is received, the server 500 may transmit a chemical container loading command to the replacement robot 100. The chemical container loading command may include a signal to receive the full container FC from the return robot 200 and load the full container FC into a container table of the replacement robot 100. The replacement robot 100 may receive the chemical container loading command, travel to the return robot 200, and receive the full container FC from the return robot 200. In addition, the replacement robot 100 may load the received full container FC into the container table of the replacement robot 100.

According to some example embodiments, the server 500 may transmit a chemical container replacement command to the replacement robot 100. The chemical container replacement command may include a signal to replace the empty container EC stored in the cabinet device 300 with the full container FC. In addition, the server 500 may transmit an open command to the cabinet device 300. The open command may include a signal to change the state of the cabinet device 300 from a closed state to an open state.

Example embodiments illustrate that the server 500 may transmit and receive various signals to and from the replacement robot 100, the return robot 200, the cabinet device 300, the container port 400, and the chemical equipment EQ and may control the overall operations of the chemical container replacement system 1000. However, this is merely an example. The chemical container replacement system 1000 may not include the server 500. In some example embodiments, the replacement robot 100, the return robot 200, the cabinet device 300, the container port 400, and the chemical equipment EQ may exchange the above-described various signals with each other and may perform the overall operations of the chemical container replacement system 1000.

For example, the replacement robot 100 may transmit the open command or the close command to the cabinet device 300. In addition, the return robot 200 may transmit the equipment arrival signal to the replacement robot 100 and may transmit the chemical container replacement command to the replacement robot 100.

As described above, the replacement robot 100, the return robot 200, the cabinet device 300, the container port 400, and the server 500 included in the chemical container replacement system 1000 according to some example embodiments may automatically replace the chemical container CC stored in the cabinet device 300 while transmitting and receiving various signals to and from each other. Accordingly, the chemical container replacement system 1000 may achieve the effect of automatically replacing the chemical container CC without requiring an operator to enter the inside of the FAB.

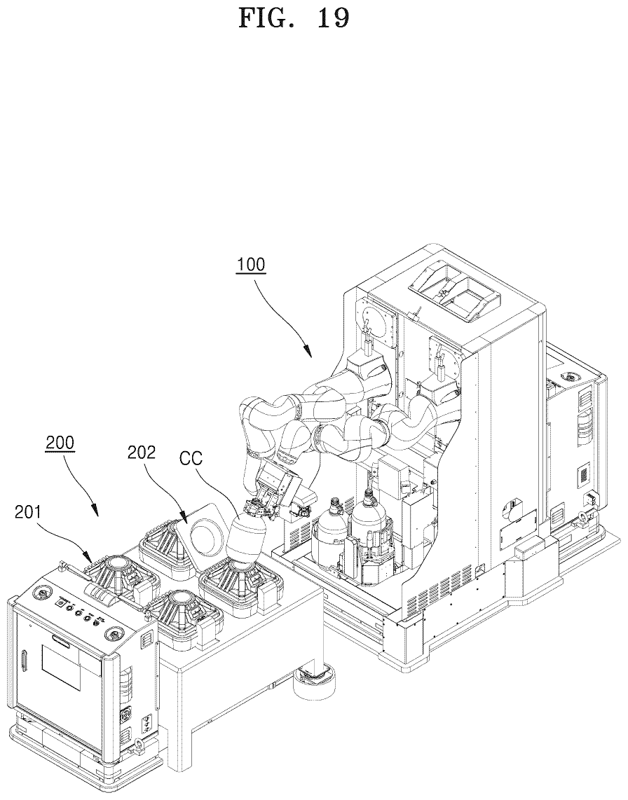

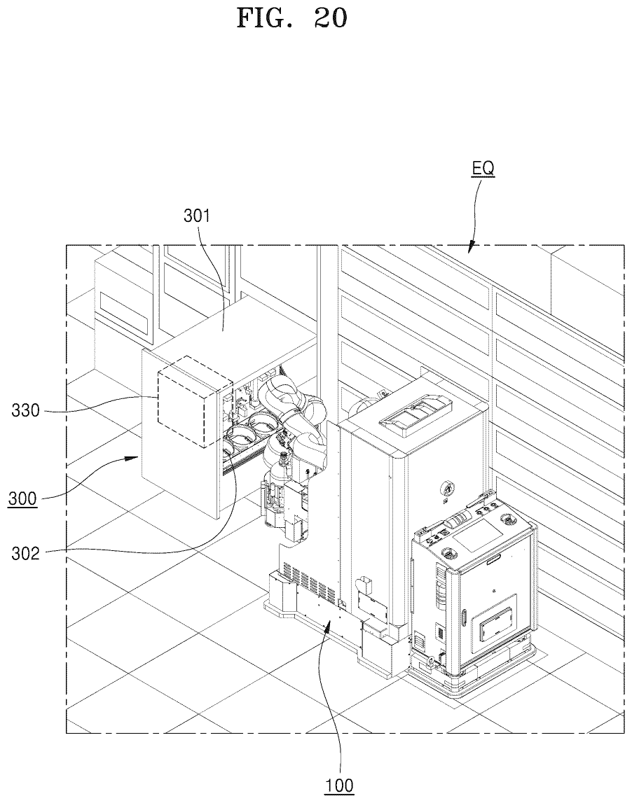

In region A of FIG. 1, the replacement robot 100 and the return robot 200 may exchange the empty container EC and the full container FC with each other. The region A of FIG. 1 is described in detail below with reference to FIG. 19. In region B of FIG. 1, the replacement robot 100 and the cabinet device 300 may exchange the empty container EC and the full container FC with each other. The region B of FIG. 1 is described in detail below with reference to FIG. 20.

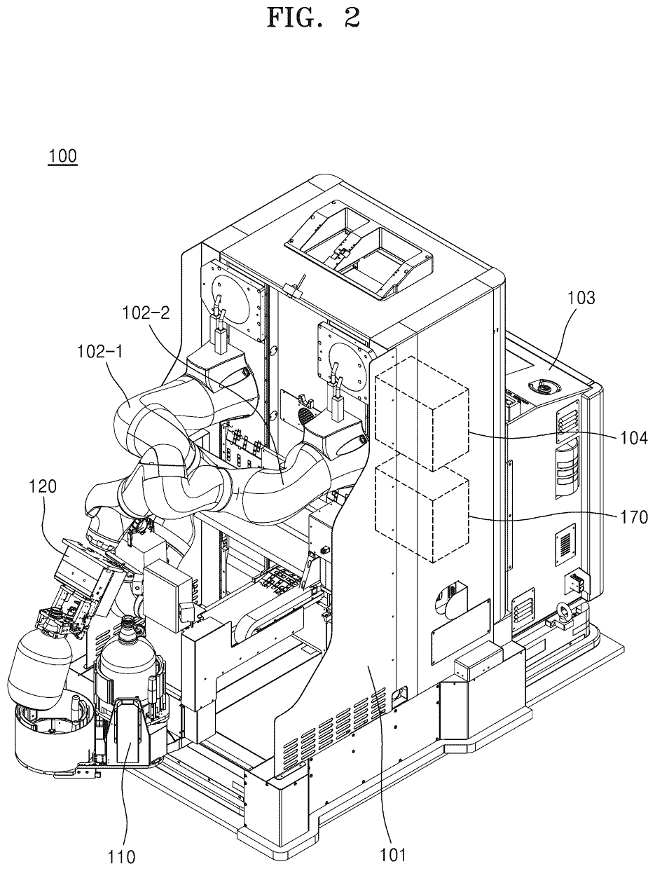

The configuration of the replacement robot 100 is described below with reference to FIGS. 2 to 20.

FIG. 2 is a perspective view of the replacement robot 100 according to some example embodiments.

Referring to FIG. 2, the replacement robot 100 may include a robot body 101, first and second robot arms 102-1 and 102-2, a traveling unit 103, a container table 110, and a control unit 170.

The robot body 101 may constitute the overall exterior of the replacement robot 100. A communication interface 104 and the control unit 170 may be included inside the robot body 101.

The first and second robot arms 102-1 and 102-2 may be mounted on the robot body 101. The first robot arm 102-1 and the second robot arm 102-2 may be spaced apart from each other. Although FIG. 2 illustrates two robot arms 102-1 and 102-2, it is not limited thereto. There may be three or more robot arms. Each of the first and second robot arms 102-1 and 102-2 may include a plurality of joints and a plurality of motors for respectively driving the plurality of joints. For example, each of the first and second robot arms 102-1 and 102-2 may have six or seven joints so as to have six or seven degrees of freedom in space. In each of the first and second robot arms 102-1 and 102-2, the plurality of motors may correspond to the plurality of joints, respectively.

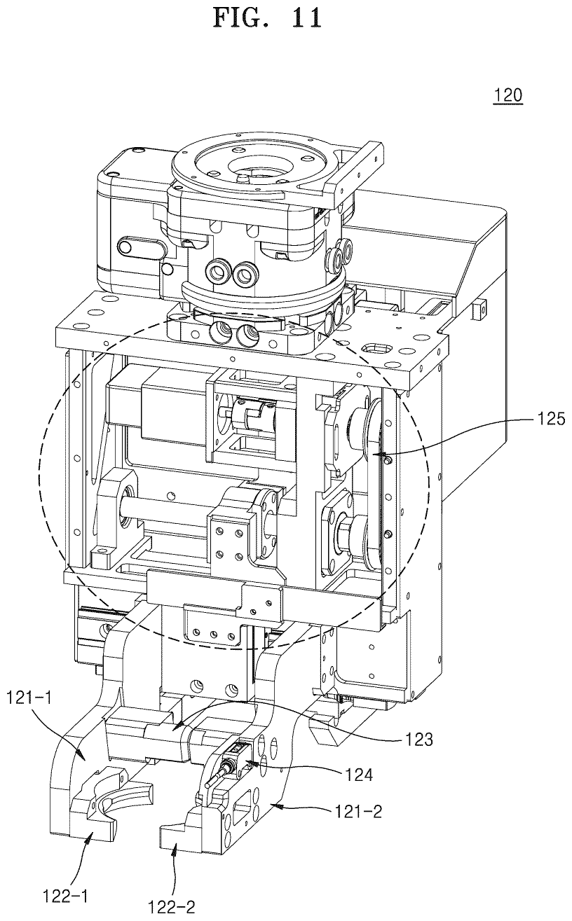

Although FIG. 2 only shows that a container gripper 120 is mounted on the second robot arm 102-2, various types of grippers may be mounted on each of the first and second robot arms 102-1 and 102-2. The various types of grippers are described below with reference to FIGS. 11 to 14.

The traveling unit 103 may move the robot body 101. As shown in FIG. 2, the traveling unit 103 may be arranged behind the robot body 101. However, the position of the traveling unit 103 is not limited thereto. The traveling unit 103 may be arranged at various positions, such as a bottom surface of the robot body 101. The traveling unit 103 may include a plurality of motors and a plurality of wheels.

The communication interface 104 may transmit or receive various types of signals to or from an external device. For example, the communication interface 104 may communicate with the server 500, the return robot 200, or the cabinet device 300.

The communication interface 104 may include a wireless communication module (e.g., an NFC module, a wireless LAN module, an IR communication module, a Zigbee communication module, a WiFi communication module, or a Bluetooth communication module). The communication interface 104 may perform wireless communication with the external device through the wireless communication module.

The container table 110 may be disposed on a front surface of the robot body 101. The empty container EC and the full container FC may be disposed on a top surface of the container table 110. The container table 110 is described below with reference to the drawings.

The control unit 170 may be operatively connected to various components included in the replacement robot 100 and may control the overall operation of the replacement robot 100. The control unit 170 may include at least one processor and memory.

The control unit 170 may be implemented in hardware, firmware, software, or any combination thereof. The control unit 170 may include a simple controller, a complex processor such as a microprocessor, a central processing unit (CPU), or a graphics processing unit (GPU), a processor configured by software, dedicated hardware, or firmware. For example, the control unit 170 may be implemented by a general purpose computer or application-specific hardware, such as a digital signal processor (DSP), a field programmable gate array (FPGA), and an application specific integrated circuit (ASIC). The control unit 170 may be implemented as commands stored on a machine-readable medium that can be read and executed by one or more processors. The machine-readable medium may include any mechanism for storing and/or transmitting information in a form readable by a machine (e.g., a computing device). For example, the machine-readable medium may include read-only memory (ROM), random-access memory (RAM), magnetic disk storage media, optical storage media, flash memory devices, electrical, optical, acoustical, or other forms of radio signals (e.g., carrier waves, infrared signals, and digital signals), and any other signals.

The replacement robot 100 including the above-described configurations may perform an operation of replacing the empty container EC stored in the cabinet device 300 with the full container FC. The replacement operation of the replacement robot 100 is described below with reference to the drawings.

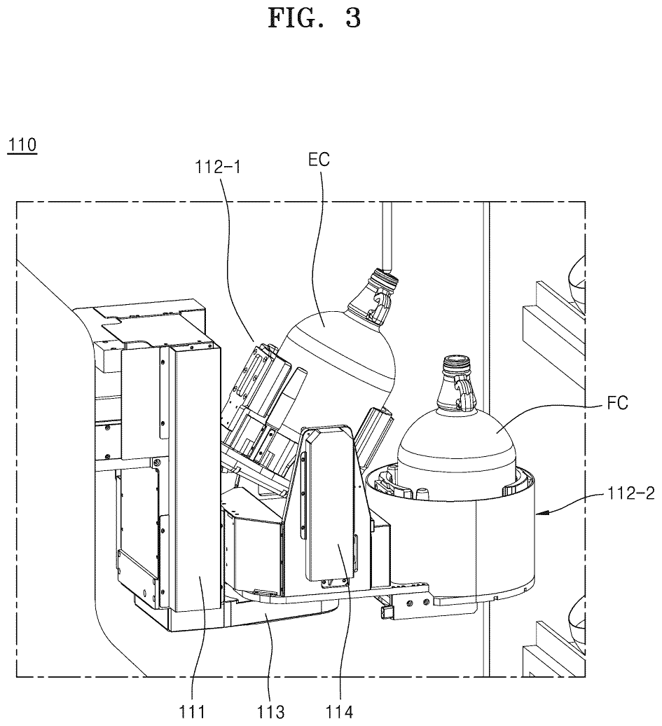

FIG. 3 is a perspective view of the container table 110 according to some example embodiments.

Referring to FIG. 3, the container table 110 may include a table body 111, a first container case 112-1, a second container case 112-2, a table body driving device 113, and a case driving device 114.

The table body 111 may constitute the overall exterior of the container table 110. The first container case 112-1 and the second container case 112-2 may be disposed on a front surface of the table body 111.

The container case 112 may include a case accommodating the chemical container CC. During the replacement operation of the replacement robot 100, the container case 112 in which the empty container EC is accommodated is referred to as the first container case 112-1 and the container case 112 in which the full container FC is accommodated is referred to as the second container case 112-2. Although FIG. 3 only shows two container cases, that is, the first and second container cases 112-1 and 112-2, included in the container table 110, this is merely an example. The container table 110 may include three or more container cases 112.

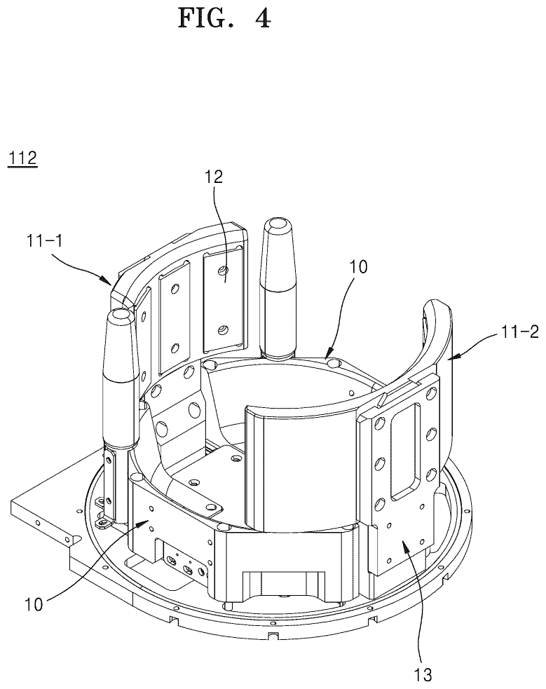

The first container case 112-1 and the second container case 112-2 may be implemented with a shape and a size corresponding to the chemical container CC. In addition, the first container case 112-1 and the second container case 112-2 may further include a fixing device for fixing, securing, and supporting the chemical container CC, and a sensor for sensing whether the chemical container CC is accommodated. The configuration of each of the first container case 112-1 and the second container case 112-2 is described with reference to FIGS. 4 to 10.

The table body driving device 113 may drive the table body 111 in the horizontal direction and in the vertical direction. For the replacement operation of the replacement robot 100, the table body driving device 113 may drive the table body 111 to a position adjacent to the cabinet device 300. When the replacement operation of the replacement robot 100 ends, the table body driving device 113 may drive the table body 111 to a position adjacent to the robot body 101.

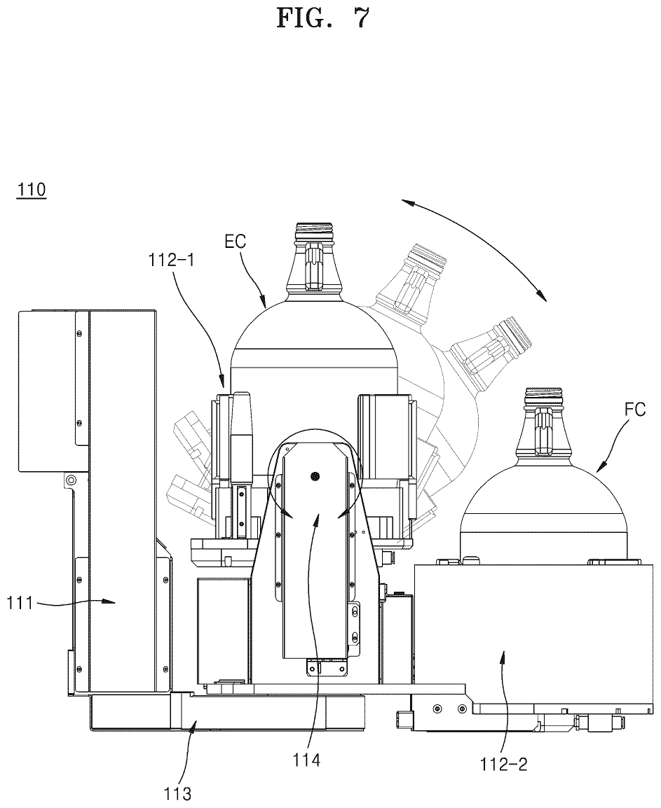

The case driving device 114 may rotate the first container case 112-1. During the replacement operation of the replacement robot 100, the case driving device 114 may rotate the first container case 112-1 toward the second container case 112-2. As the case driving device 114 rotates the first container case 112-1, the empty container EC accommodated in the first container case 112-1 may also be rotated. The operation of rotating the first container case 112-1 by the case driving device 114 is described below with reference to FIGS. 7, 8, 16A to 16F, 17, and 18.

The container table 110 including the above-described configuration may stably accommodate the empty container EC and the full container FC. A method of fixing and supporting the chemical container CC by the container case 112 is described in detail below with reference to FIGS. 4 to 6E.

FIG. 4 is a perspective view of the container case 112 according to some example embodiments.

Referring to FIG. 4, the container case 112 may include a case guide 10, a plurality of fixing plates 11-1 and 11-2, and a container fixing device 13.

The case guide 10 may define a space in which the chemical container CC is accommodated. The case guide 10 may be implemented in a shape corresponding to the exterior of the chemical container CC. As an example, when the lower exterior of the chemical container CC has a shape of a cylinder, the case guide 10 may also be implemented in a shape for enclosing the cylinder. The case guide 10 may guide the downward movement of the chemical container CC. The case guide 10 may support a lower portion of the chemical container CC. In addition, the case guide 10 may be fixedly and/or securely disposed on the table body 111.

The plurality of fixing plates 11-1 and 11-2 may be arranged above the case guide 10. The plurality of fixing plates 11-1 and 11-2 may fix both sides of the chemical container CC. Each of the plurality of fixing plates 11-1 and 11-2 may include a contact pad 12. The contact pad 12 may include a friction material and may fix and support the chemical container CC based on friction with the chemical container CC. Although FIG. 4 only shows that the plurality of fixing plates 11-1 and 11-2 are implemented as two fixing plates, this is merely an example. The plurality of fixing plates 11-1 and 11-2 may also be implemented as three or more fixing plates.

The container fixing device 13 may drive the plurality of fixing plates 11-1 and 11-2. When it is detected that the chemical container CC is accommodated in the container case 112, the container fixing device 13 may drive each of the plurality of fixing plates 11-1 and 11-2 toward the chemical container CC. The container fixing device 13 may drive each of the plurality of fixing plates 11-1 and 11-2 so that the contact pad 12 disposed on the inner surface of each of the plurality of fixing plates 11-1 and 11-2 is in contact with the chemical container CC. The container fixing device 13 may include at least one motor and a gear. In some example embodiments, the container fixing device 13 may be implemented as a driving device for driving the plurality of fixing plates 11-1 and 11-2 based on pneumatic pressure.

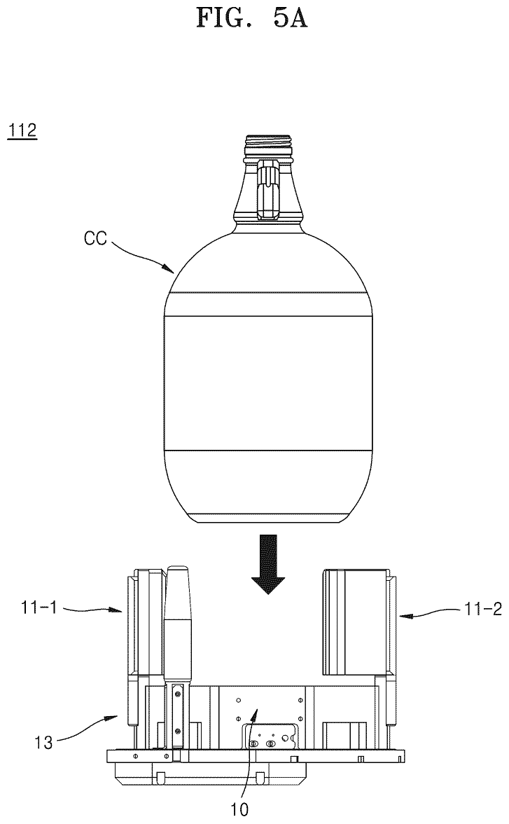

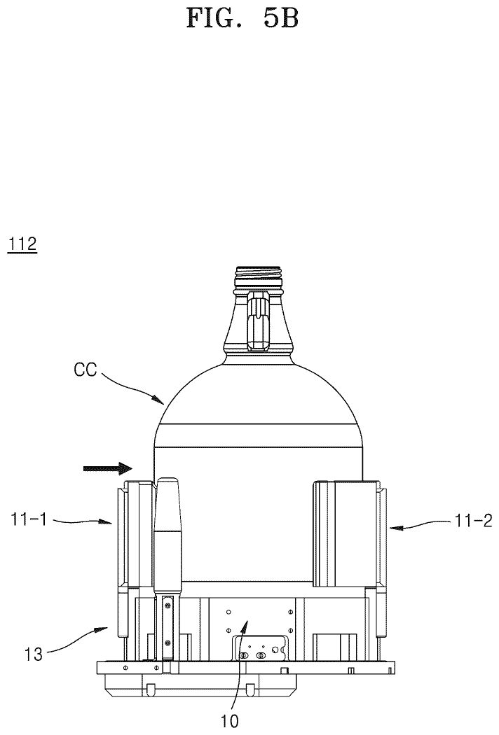

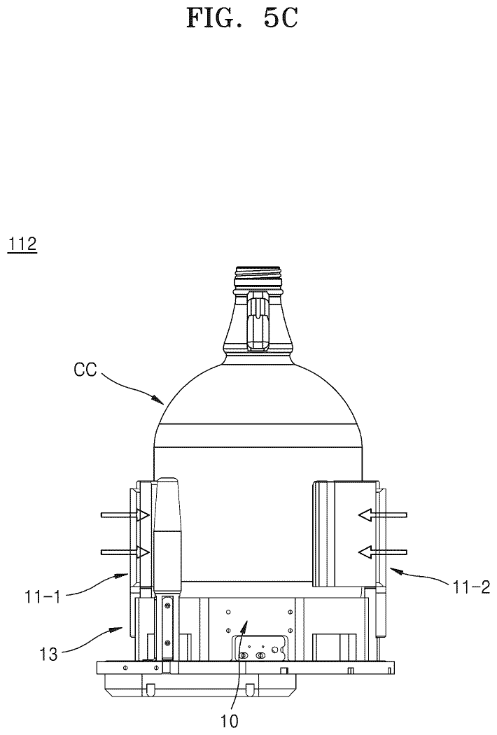

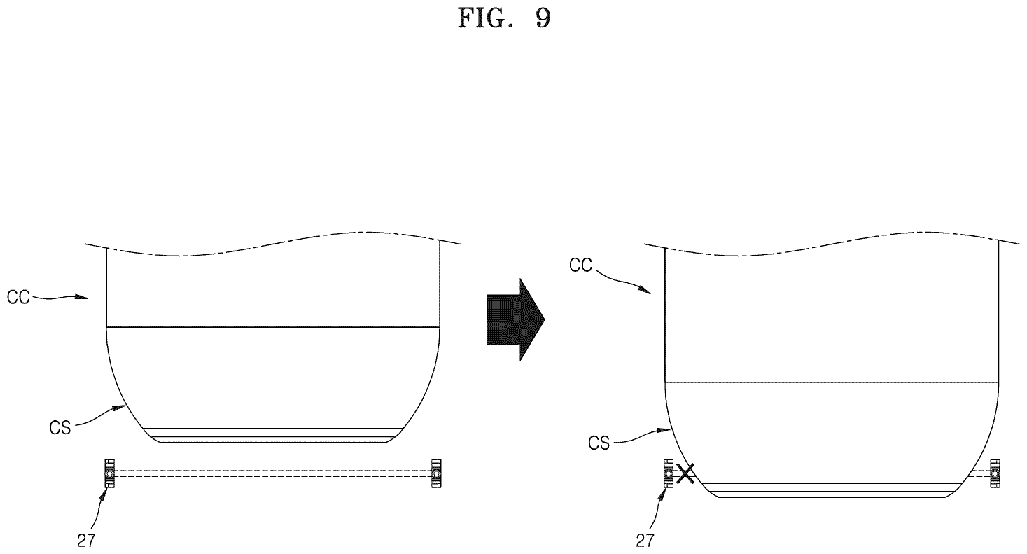

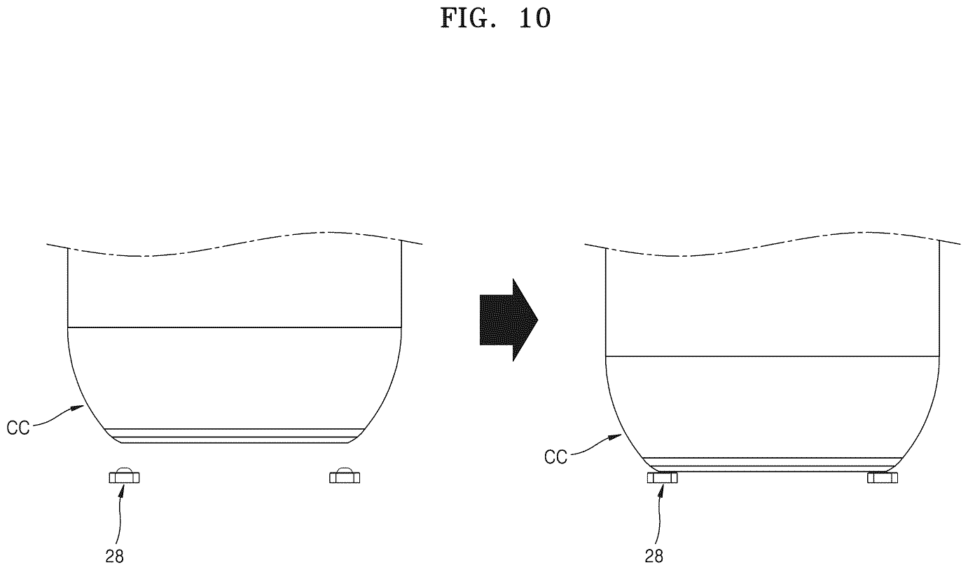

The container case 112 may further include a sensor that confirms whether the chemical container CC has been received. The sensor is described below with reference to FIGS. 9 and 10. In addition, the operation of fixing and supporting the chemical container CC based on the container fixing device 13 is described below with reference to FIGS. 5A to 5C.

FIGS. 5A to 5C are diagrams illustrating an operation of the container case 112 according to some example embodiments.

Referring to FIG. 5A, the replacement robot 100 may transfer the chemical container CC to the case guide 10. The replacement robot 100 may grip the chemical container CC through the robot arm 102 and the container gripper 120 mounted on the robot arm 102 and may transfer the chemical container CC to the case guide 10. The chemical container CC may be transferred to the case guide 10 through the downward movement. The replacement robot 100 may transfer the chemical container CC to align the central axis of the chemical container CC with the central axis of the case guide 10.

Before the chemical container CC moves toward the case guide 10, the plurality of fixing plates 11-1 and 11-2 may be in an expanded state. When the plurality of fixing plates 11-1 and 11-2 are in the expanded state, each of the plurality of fixing plate 11-1 and 11-1 may be spaced apart from the central axis of the container case 112. Accordingly, the chemical container CC may be moved toward the case guide 10 with relative ease.

Referring to FIG. 5B, when it is identified by the sensor that the chemical container CC has been placed in the case guide 10, the container fixing device 13 may drive each of the plurality of fixing plates 11-1 and 11-2 toward the chemical container CC. The sensor may sense whether the chemical container CC has been placed in the case guide 10 based on a method of sensing a change in pressure and/or an optical method.

The container fixing device 13 may move each of the plurality of fixing plates 11-1 and 11-2 by the same distance, for example, uniformly or symmetrically. Each of the plurality of fixing plates 11-1 and 11-2 may be radially moved toward the center of the container case 112.

Referring to FIG. 5C, the container fixing device 13 may radially move the plurality of fixing plates 11-1 and 11-2 such that the contact pad 12 disposed on the inner surface of each of the plurality of fixing plates 11-1 and 11-2 contacts the outer surface of the chemical container CC.

The chemical container CC may be in contact with the contact pad 12 disposed on the inner surface of each of the plurality of fixing plates 11-1 and 11-2. The contact pad 12 may include a friction material. The contact pad 12 may fix and support the chemical container CC based on friction with the outer surface of the chemical container CC. As described above, the plurality of fixing plates 11-1 and 11-2 may prevent or limit the chemical container CC from being detached from the container case 112 based on the operation of fixing and supporting the chemical container CC. As the chemical container CC is prevented or limited from being detached, the chemical container CC may be prevented or limited from falling to the bottom and cracking. In addition, the plurality of fixing plates 11-1 and 11-2 may prevent or limit the chemical container CC from rotating inside the container case 112. As the chemical container CC is prevented or limited from rotating, the air bubbles inside the contents of the chemical container CC may be suppressed and the backflow may also be suppressed.

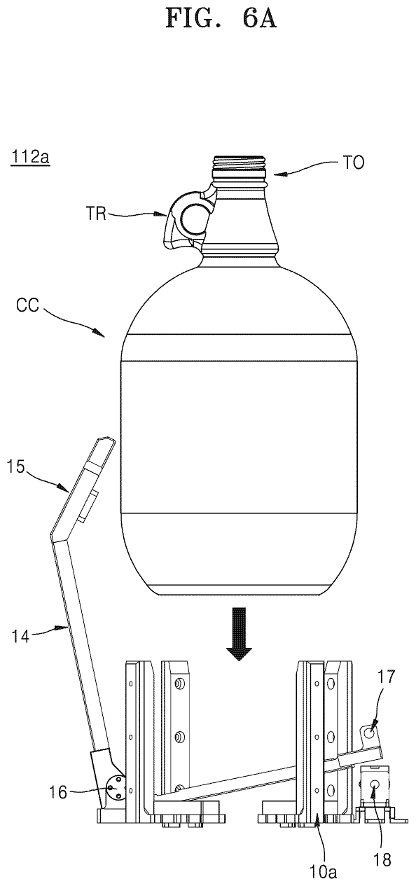

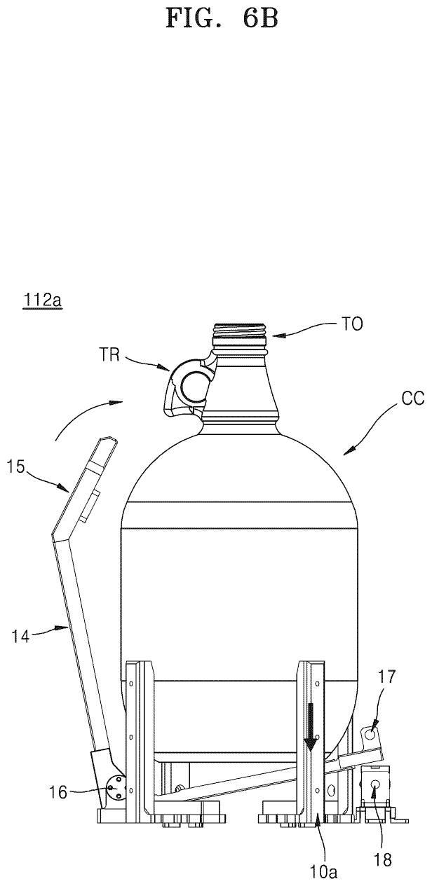

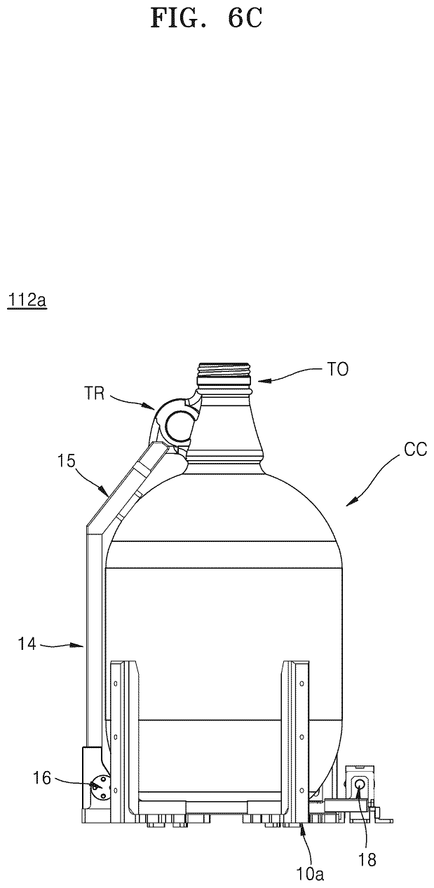

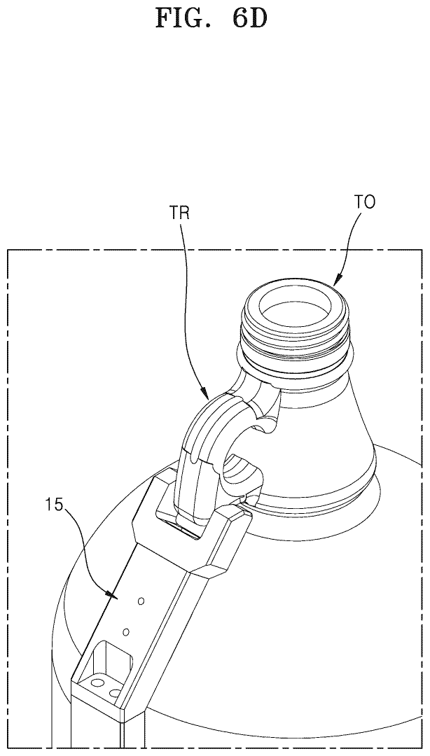

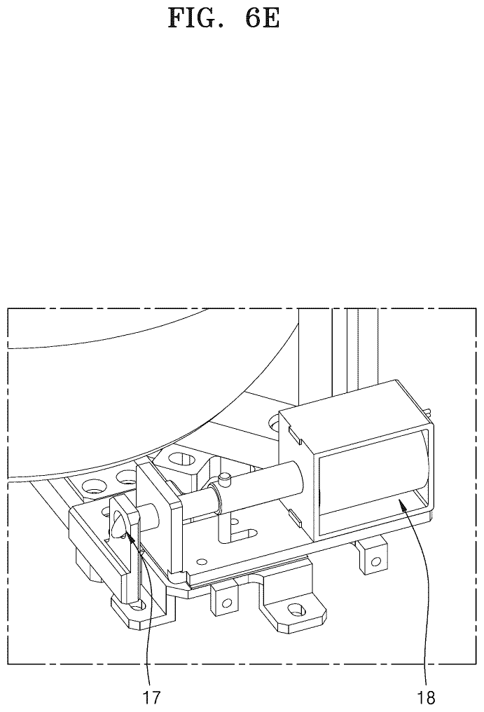

FIGS. 6A to 6E are diagrams illustrating an operation of a container case 112a according to some example embodiments.

Referring to FIG. 6A, the container case 112a may include a case guide 10a, a fixing structure 14, and a locking device 18.

The case guide 10a may support the lower portion of the chemical container CC. The bottom surface of the case guide 10a may be fixedly disposed on the table body 111. As shown in FIG. 6A, the case guide 10a may be implemented as a plurality of guides (e.g., four guides) radially spaced apart from each other with respect to the central axis of the container case 112a an uniformly separated from each other circumferentially. Each of the plurality of guides may include a horizontal part in contact with the bottom surface of the chemical container CC and a vertical part in contact with a side surface of the chemical container CC. The plurality of guides may be spaced apart from each other to correspond to the size of the exterior of the chemical container CC. When the chemical container CC is accommodated in the container case 112a, the plurality of guides may be spaced apart from each other to bring the outer surface of the chemical container CC into contact with each of the plurality of guides.

The fixing structure 14 may be in contact with the bottom surface and the side surface of the chemical container CC to fix the chemical container CC. The fixing structure 14 may include an “L” shaped structure. In other words, the fixing structure 14 may include a horizontal part extending in the horizontal direction and a vertical part extending in the vertical direction. The horizontal part of the fixing structure 14 may be in contact with the bottom surface of the chemical container CC and the vertical part of the fixing structure 14 may be in contact with the side surface of the chemical container CC.

The fixing structure 14 may include a pin 15. The pin 15 may be arranged at an end of the vertical part of the fixing structure 14 and may be connected to a top ring TR of the chemical container CC to support the top ring TR. The pin 15 may be connected to both sides of the top ring TR of the chemical container CC to support the top ring TR. The top ring TR of the chemical container CC may be arranged below an upper inlet TO of the chemical container CC. The top ring TR may be arranged above the chemical container CC for convenient transfer of the chemical container CC.

The fixing structure 14 may include a hole 17. The hole 17 may be arranged at the end of the horizontal part of the fixing structure 14 and may form a connection with the locking device 18. The hole 17 may be connected to the locking device 18 so that the fixing structure 14 is fixed to the case guide 10a.

The fixing structure 14 may include a spring 16. The spring 16 may be arranged at a corner point of the fixing structure 14 and may operate between an open state and a fixed state. The corner point of the fixing structure 14 may refer to a corner point of the “L” shape. In other words, the corner point of the fixing structure 14 may include a point where the horizontal part and the vertical part of the fixing structure 14 meet.

The spring 16 may be implemented as a torsion spring. As shown in FIG. 6A, when the spring 16 is in the open state, the horizontal part of the fixing structure 14 may be tilted counterclockwise with respect to the case guide 10a. In addition, as shown in FIG. 6C, when the spring 16 is in the fixed state, the horizontal part of the fixing structure 14 may be fixed in parallel to the case guide 10a.

The locking device 18 may be connected to the case guide 10a and may be connected to the hole 17 of the fixing structure 14 to fix the fixing structure 14 to the case guide 10a. The locking device 18 may be arranged at a position symmetrical to the position of the spring 16 with respect to the center of the container case 112a.

According to some example embodiments, the replacement robot 100 may transfer the chemical container CC to the case guide 10a. The replacement robot 100 may transfer the chemical container CC toward the case guide 10a by using the robot arm 102 and the container gripper 120 mounted on the robot arm 102. In some example embodiments, the replacement robot 100 may transfer the chemical container CC toward the case guide 10a to align the top ring TR of the chemical container CC with the pin 15. When the spring 16 is in the fixed state, the replacement robot 100 may align the chemical container CC with the pin 15 to transfer the chemical container CC toward the case guide 10a, to connect the top ring TR of the chemical container CC to the pin 15.

When the spring 16 is in the open state, as shown in FIG. 6A, the fixing structure 14 may be tilted counterclockwise by a first angle. The first angle may refer to an angle that does not interfere with the movement of the chemical container CC in the vertical direction. For example, the first angle may be between about 10 degrees and about 40 degrees.

Referring to FIG. 6B, the bottom surface of the chemical container CC may be in contact with the horizontal part of the fixing structure 14. Due to the downward movement of the chemical container CC, a clockwise torque may be applied to the horizontal part of the fixing structure 14. Based on the clockwise torque applied to the horizontal part of the fixing structure 14, the fixing structure 14 may rotate clockwise.

Referring to FIG. 6C, the spring 16 may be in the fixed state, the horizontal part of the fixing structure 14 may be in contact with the bottom surface of the chemical container CC, and the vertical part of the fixing structure 14 may be in contact with the side surface of the chemical container CC. In addition, the locking device 18 may be connected to the hole 17 of the fixing structure 14 to fix the fixing structure 14. The pin 15 of the fixing structure 14 may be connected to the top ring TR of the chemical container CC to support the top ring TR.

FIG. 6D is an enlarged view of a portion of the top ring TR of the chemical container CC shown in FIG. 6C. Referring to FIG. 6D, the pin 15 of the fixing structure 14 may be connected to both sides of the top ring TR of the chemical container CC to fix and support the chemical container CC. As a result, the chemical container CC may be prevented or limited from being detached from the container case 112a or the chemical container CC may be prevented or limited from rotating inside the container case 112a.

FIG. 6E is an enlarged view of a portion of the locking device 18 shown in FIG. 6C. Referring to FIG. 6E, the locking device 18 may include a pin structure that is insertable into the hole 17. When the spring 16 is in the fixed state, the hole 17 of the fixing structure 14 may be aligned with the locking device 18. The hole 17 of the fixing structure 14 may be arranged adjacent to the pin structure of the locking device 18 and may be arranged at the same vertical level as the pin structure thereof. The pin structure of the locking device 18 may be inserted into the hole 17 of the fixing structure 14 to form a connection with the fixing structure 14 and to fix the fixing structure 14 to the case guide 10a.

As described above with reference to FIGS. 6A to 6E, the container case 112a including the fixing structure 14 which rotates clockwise or counterclockwise in response to the movement of the chemical container CC in the vertical direction may passively accommodate the chemical container CC. As the container case 112a passively accommodates the chemical container CC, the container case 112a may not include the sensor for sensing the chemical container CC.

For convenience of description, only the process of accommodating the chemical container CC in the container case 112 is described with reference to FIGS. 5A to 5C, and 6A to 6C. It may be understood by those skilled in the art that the process of removing the chemical container CC from the container case 112 to the outside of the container case 112 may be performed in the reverse order to the above-described process of accommodating the chemical container CC. Thus, the description thereof is omitted.

FIG. 7 is a diagram illustrating an operation of the container table 110 according to some example embodiments.

Referring to FIG. 7, the case driving device 114 of the container table 110 may rotate the first container case 112-1 where the empty container EC is accommodated toward the second container case 112-2.

According to some example embodiments, the first container case 112-1 may be arranged at a relatively higher vertical level than the second container case 112-2. For example, the first container case 112-1 may be placed at a higher vertical level than the second container case 112-2 by more than half of the total height of the chemical container CC. As the first container case 112-1 is arranged at a relatively higher vertical level than the second container case 112-2, the upper inlet of the empty container EC accommodated in the first container case 112-1 may be rotated to a position adjacent to the upper inlet of the full container FC.

According to some example embodiments, the case driving device 114 may be connected to both sides of the first container case 112-1 to rotate the first container case 112-1. In some example embodiments, the case driving device 114 may include at least one motor, a gear, and a belt for transmitting rotational power to the first container case 112-1. The case driving device 114 may rotate the first container case 112-1 about a virtual axis passing through the empty container EC. The virtual axis may include an axis located at a lower vertical level than the central axis of the empty container EC and the virtual axis may also include an axis located at a higher vertical level than the bottom surface of the first container case 112-1. The virtual axis may include an axis oriented in a direction perpendicular to the horizontal direction from the center of the first container case 112-1 toward the center of the second container case 112-2.

According to some example embodiments, the case driving device 114 may rotate the first container case 112-1 such that at least a part of the upper inlet of the empty container EC accommodated in the first container case 112-1 overlaps with the upper inlet of the full container FC accommodated in the second container case 112-2 in the vertical direction. As at least a part of the upper inlet of the empty container EC is rotated to overlap with the upper inlet of the full container FC in the vertical direction, a small amount of toxic content present in a tube T of an equipment cap module TC may be prevented or limited from being discharged to the outside of the chemical container CC during the replacement operation of the replacement robot 100.

In addition, the case driving device 114 may further include a vertical driving unit that changes a vertical level of the first container case 112-1. In some example embodiments, the case driving device 114 may rotate the first container case 112-1 along a plurality of rotational trajectories respectively corresponding to a plurality of vertical levels at which the first container case 112-1 can be placed.

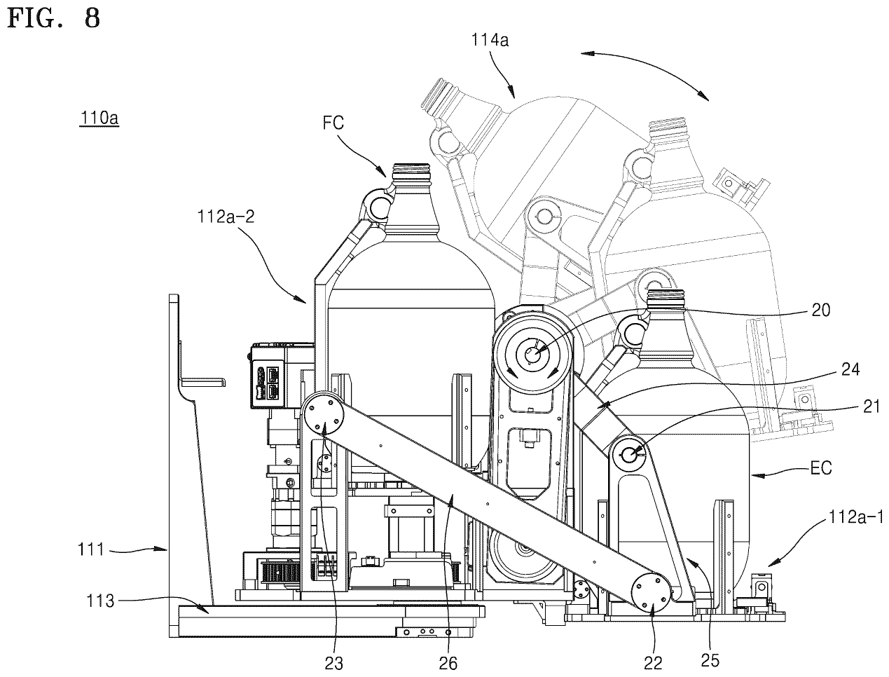

FIG. 8 is a diagram illustrating an operation of another container table 110a according to some example embodiments.

Referring to FIG. 8, a case driving device 114a of the container table 110a may be implemented as a four-section link driving device. In some example embodiments, a first container case 112a-1 accommodating the empty container EC may be placed at a relatively lower vertical level than a second container case 112a-2 accommodating the full container FC.

According to some example embodiments, the case driving device 114a may include a first fixed joint 20, a first rotary joint 21, a second rotary joint 22, a second fixed joint 23, an input link 24, a coupler 25, an output link 26, and a driving module that provides a driving force to the input link 24.

The first fixed joint 20 may be fixedly arranged between the first container case 112a-1 and the second container case 112a-2. The second fixed joint 23 may be fixedly disposed on the second container case 112a-2. The first fixed joint 20 and the second fixed joint 23 may not be changed in position while the first container case 112a-1 is rotated.

The first rotary joint 21 and the second rotary joint 22 may be fixedly disposed on the first container case 112a-1. As shown in FIG. 8, as the first rotary joint 21 and the second rotary joint 22 are fixed to the first container case 112a-1, the first rotary joint 21 and the second rotary joint 22 may be moved together while the first container cases 112a-1 is rotated. The first rotary joint 21 may rotate about the first fixed joint 20 and the second rotary joint 22 may rotate about the second fixed joint 23. As an example, the first rotary joint 21 may be fixed to an upper portion of the first container case 112a-1, and the second rotary joint 22 may be fixed to a lower portion of the first container case 112a-1.

The input link 24 may connect the first fixed joint 20 to the first rotary joint 21. In addition, the input link 24 may be connected to a driving module (e.g., a rotary motor or a pneumatic cylinder) that provides the rotational power. As shown in FIG. 8, the input link 24 may be rotated clockwise or counterclockwise by receiving the rotational power.

The coupler 25 may connect the first rotary joint 21 to the second rotary joint 22. In addition, the coupler 25 may connect the input link 24 to the output link 26. The coupler 25 may transmit power received from the input link 24 to the output link 26. As the coupler 25, together with the first rotary joint 21 and the second rotary joint 22, fixed to the first container case 112a-1, may be moved together while the first container case 112a-1 is rotated.

The output link 26 may connect the second rotary joint 22 to the second fixed joint 23. In addition, the output link 26 may be connected to the coupler 25. The output link 26 may receive power from the coupler 25 and may be rotated based on the received power.

The case driving device 114a of the four-section link structure as shown in FIG. 8 may also rotate the first container case 112a-1 such that at least a part of the upper inlet of the empty container EC accommodated in the first container case 112a-1 overlaps with the upper inlet of the full container FC in the vertical direction. In some example embodiments, the case driving device 114a may drive the first container case 112a-1 to rotate the empty container EC in a tilted state toward the full container FC while being driven in a vertically upward direction.

As described above, as at least a part of the upper inlet of the empty container EC is rotated to vertically overlap with the upper inlet of the full container FC, a small amount of toxic content present in the tube T of the equipment cap module TC may be prevented or limited from being discharged to the outside of the chemical container CC during the replacement operation of the replacement robot 100.

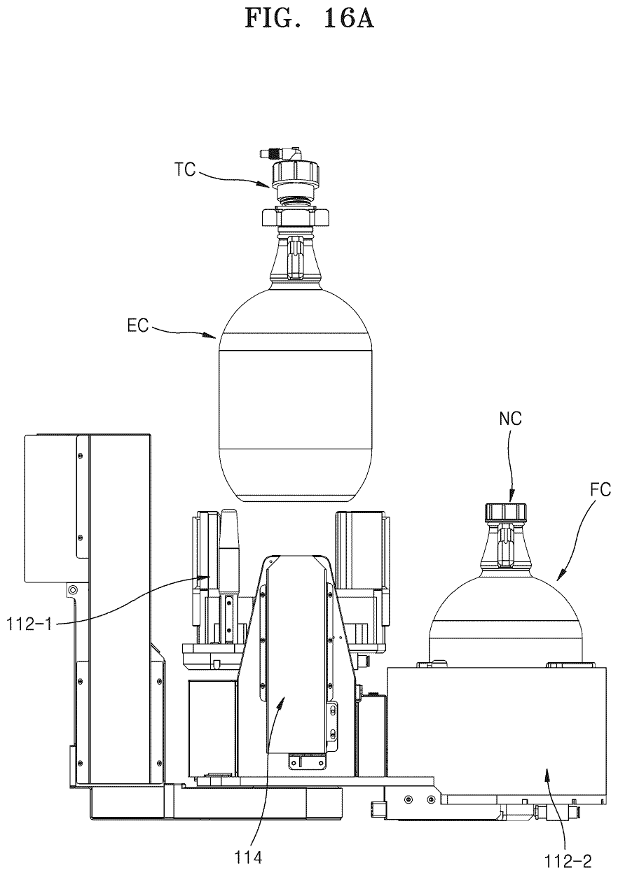

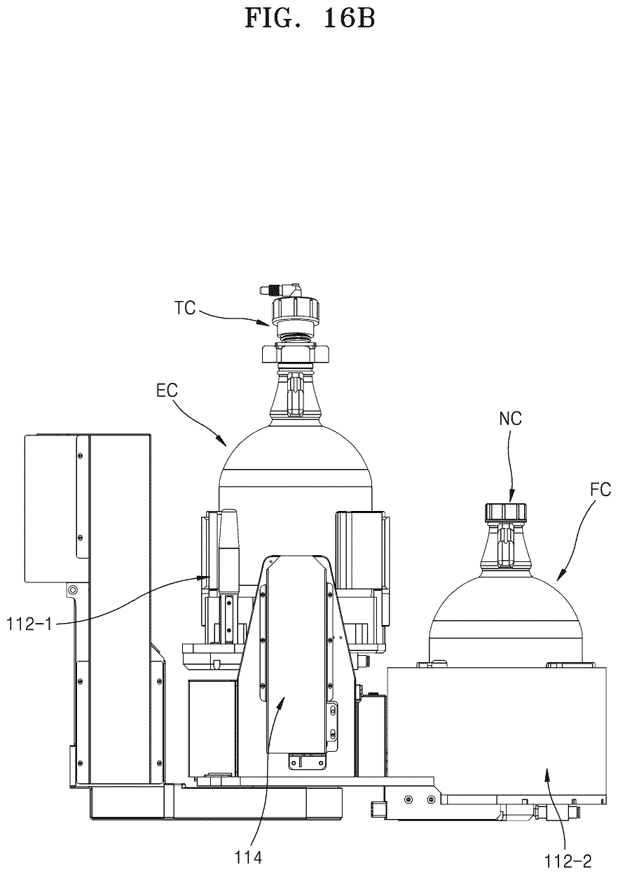

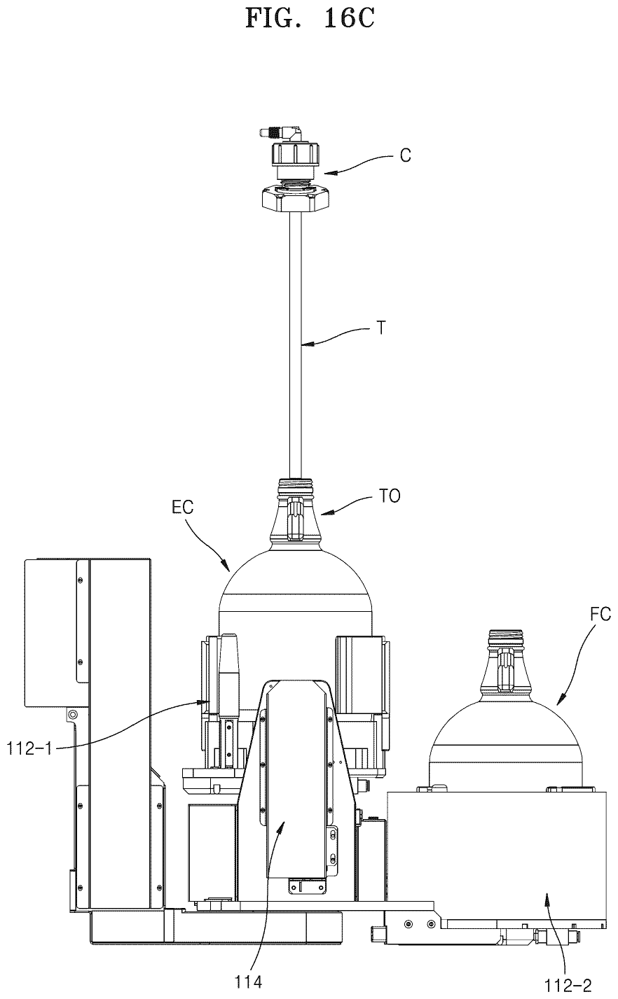

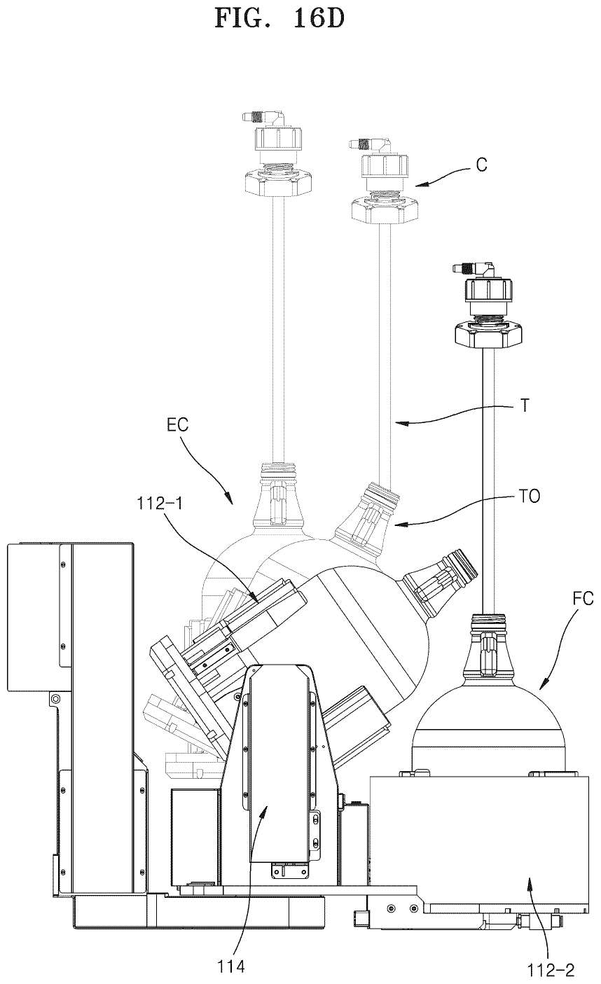

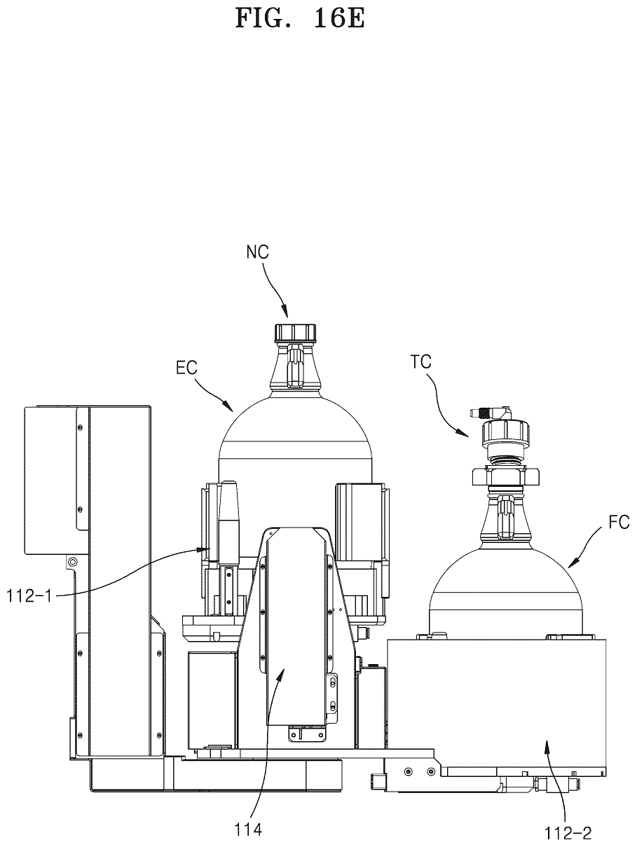

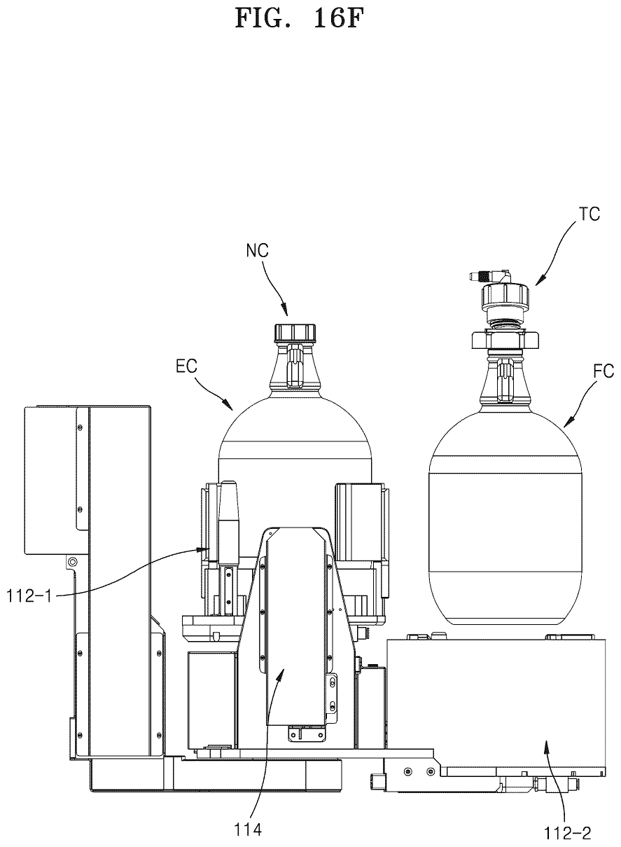

An operation for preventing or limiting the small amount of toxic content present in the tube T of the equipment cap module TC from being discharged is described below with reference to FIGS. 16A to 16F, 17, and 18.

FIG. 9 is a diagram illustrating a method of detecting whether a container is accommodated or located in the container case 112, according to some example embodiments.

Referring to FIG. 9, a light sensor 27 may be arranged below the container case 112.

The light sensor 27 may include a light source and a light receiver respectively disposed on both sides of the container case 112. The light source and the light receiver of the light sensor 27 may be arranged at the same vertical level. The light sensor 27 may identify that the container case 112 does not accommodate the chemical container CC when the light receiver senses the light. Conversely, the light sensor 27 may identify that the container case 112 has accommodated the chemical container CC when no light is sensed by the light receiver.

The vertical level of the light sensor 27 installed inside the container case 112 may be determined based on the shape of the chemical container CC.

According to some example embodiments, the light sensor 27 may be arranged at a vertical level corresponding to a vertical level of a lower curved surface CS of the chemical container CC. The lower curved surface CS of the chemical container CC may refer to a curved surface connecting the sidewall of the chemical container CC to the bottom surface of the chemical container CC. The lower curved surface CS of the chemical container CC may be implemented as a curved surface with a downward convex shape, as shown in FIG. 9, for structural stability. In addition, “the vertical level corresponding to the lower curved surface CS of the chemical container CC” may refer to “the vertical level at which the lower curved surface CS is arranged when the chemical container CC is completely accommodated in the container case 112”.

Since the light sensor 27 is arranged at a vertical level corresponding to the vertical level of the lower curved surface CS, the light sensor 27 may detect whether the chemical container CC of the container case 112 is accommodated even when the chemical container CC is made of a light-transmitting glass material. When the chemical container CC is not accommodated in the container case 112, the light emitted from the light source of the light sensor 27 may reach the light receiver of the light sensor 27. On the other hand, when the chemical container CC is accommodated in the container case 112, the light emitted from the light source of the light sensor 27 may be refracted by the lower curved surface CS. The light refracted by the lower curved surface CS may not reach the light receiver of the light sensor 27. Accordingly, the light sensor 27 may sense whether the chemical container CC is accommodated in the container case 112, depending on whether the light receiver of the light sensor 27 senses light.

FIG. 10 is a diagram illustrating a method of detecting whether the container is accommodated in the container case 112, according to some example embodiments.

Referring to FIG. 10, a push sensor 28 may be arranged below the container case 112.

The push sensor 28 may identify, based on the magnitude of the pressure, whether the chemical container CC has been received in the container case 112. In some example embodiments, as shown in FIG. 10, two push sensors 28 may each be arranged below the container case 112.

When the chemical container CC is accommodated in the container case 112, the push sensor 28 may be in contact with the bottom surface of the chemical container CC. Accordingly, the magnitude of the pressure applied to the push sensor 28 may be relatively large. On the other hand, when the chemical container CC is not accommodated in the container case 112, the magnitude of the pressure applied to the push sensor 28 may be relatively small. Accordingly, the push sensor 28 may sense, based on the magnitude of the pressure applied to the push sensor 28, whether the chemical container CC is accommodated in the container case 112.

Although FIG. 10 only shows two push sensors 28 arranged below the container case 112, this is merely an example. Two or more push sensors 28 or only one push sensor 28 may be arranged below the container case 112. In addition, although FIG. 10 only shows that the two push sensors 28 are in contact with the edge of the chemical container CC, the push sensors 28 may also be arranged at various positions below the container case 112, such as the center of the bottom surface of the chemical container CC.

Various types of grippers that can be mounted on the robot arm 102 of the replacement robot 100 are described below with reference to FIGS. 11 to 14.

FIG. 11 is a perspective view of the container gripper 120 according to some example embodiments.

Referring to FIG. 11, the container gripper 120 may include first and second fingers 121-1 and 121-2, a ring penetrating part 123, a light sensor 124, and a finger driving device 125.

Each of the first and second fingers 121-1 and 121-2 may include a plurality of configurations for gripping the chemical container CC. As an example, the first finger 121-1 may include a first contact part 122-1 and the second finger 121-2 may include a second contact part 122-2. The first contact part 122-1 and the second contact part 122-2 may be in direct contact with the chemical container CC and may form a connection with the chemical container CC.

Each of the first contact part 122-1 and the second contact part 122-2 may have a shape corresponding to a bottleneck of the chemical container CC. The first contact part 122-1 and the second contact part 122-2 may be connected to the inside of the first finger 121-1 and the second finger 121-2, respectively. The first contact part 122-1 and the second contact part 122-2 may be arranged at the same vertical level. In the operation of gripping the chemical container CC by the container gripper 120, the interval between the first contact part 122-1 and the second contact part 122-2 may decrease, and each of the first contact part 122-1 and the second contact part 122-2 may be respectively connected to both sides of the bottleneck of the chemical container CC.

The ring penetrating part 123 may penetrate the top ring TR of the chemical container CC. By inserting the ring penetrating part 123 into the top ring TR of the chemical container CC, the chemical container CC may be prevented or limited from falling even when the first contact part 122-1 and the second contact part 122-2 fail to fix the chemical container CC.

The ring penetrating part 123 may include a first penetrating part fixed to the first finger 121-1 and a second penetrating part fixed to the second finger 121-2. In the operation of gripping the chemical container CC by the container gripper 120, the first penetrating part may be connected to the second penetrating part. Referring to FIG. 6C again, the first penetrating part and the second penetrating part of the ring penetrating part 123 may be inserted into a circular hole surrounded by the top ring TR of the chemical container CC and the connection between the first penetrating part and the second penetrating part may be formed inside the circular hole. Accordingly, the ring penetrating part 123 may penetrate the top ring TR of the chemical container CC, thereby preventing or limiting the chemical container CC from falling.

The light sensor 124 may identify the gripping state of the chemical container CC by the container gripper 120. The light sensor 124 may be connected to the outside of the first finger 121-1 or the second finger 121-2.

The finger driving device 125 may drive the first and second fingers 121-1 and 121-2. The finger driving device 125 may decrease or increase an interval between the first finger 121-1 and the second finger 121-2. As an example, in the operation of gripping the chemical container CC by the container gripper 120, the finger driving device 125 may drive the first finger 121-1 and the second finger 121-2 in the horizontal direction to decrease the interval between the first finger 121-1 and the second finger 121-2. As another example, in the operation of releasing the chemical container CC by the container gripper 120, the finger driving device 125 may drive the first finger 121-1 and the second finger 121-2 in the horizontal direction to increase the interval between the first finger 121-1 and the second finger 121-2.

The finger driving device 125 may include at least one spring, a motor, a gear, a belt, or the like, for the driving as described below. Although it is only shown that the finger driving device 125 may drive the first finger 121-1 and the second finger 121-2 in the horizontal direction, the finger driving device 125 may drive the first and second fingers 121-1 and 121-2 in the vertical direction to drive the chemical container CC in the vertical direction. The method of driving the first and second fingers 121-1 and 121-2 by the finger driving device 125 is not limited to the above-described example.

The container gripper 120 may include the configurations as described above, thereby stably gripping/releasing the chemical container CC in the operation of replacing the chemical container CC by the replacement robot 100.

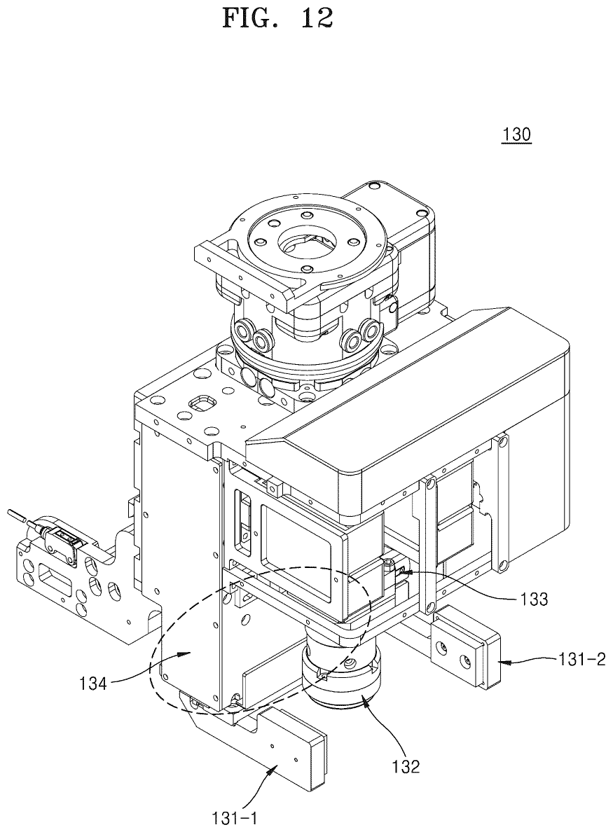

FIG. 12 is a perspective view of an equipment cap gripper 130 according to some example embodiments.

Referring to FIG. 12, the equipment cap gripper 130 may include first and second fingers 131-1 and 131-2, a rotary motor 132, a light sensor 133, and a finger driving device 134. The equipment cap gripper 130 may separate the equipment cap module TC from the empty container EC and may connect the equipment cap module TC to the full container FC.

The equipment cap module TC, which is a module that connects the chemical equipment EQ to the chemical container CC, may be configured to supply contents (e.g., PR) contained in the chemical container CC to the chemical equipment EQ. The equipment cap module TC may include a cap C that seals the upper inlet TO of the chemical container CC, and the tube T that is connected to a lower portion of the cap C and inserted into the chemical container CC. In addition, the cap C may include a sealing unit connected to the upper inlet TO of the chemical container CC and a power transmission unit configured to transmit the rotational power to the sealing unit.

The first and second fingers 131-1 and 131-2 may be connected to both sides of the equipment cap module TC to fix the equipment cap module TC. The first finger 131-1 and the second finger 131-2 may be connected to a first side and an opposite second side of the equipment cap module TC, respectively.

The rotary motor 132 may be connected to the equipment cap module TC to provide the rotational power or torque to the equipment cap module TC. The rotary motor 132 may be connected to the power transmission unit of the cap C and may transmit the rotational power to the power transmission unit of the cap C. When the rotary motor 132 transmits the rotary power to the power transmission unit of the cap C, the power transmission unit may rotate to rotate the sealing unit of the cap C connected to the power transmission unit. As the sealing unit of the cap C is rotated, the sealing unit of the cap C may be separated from or may be connected to the upper inlet TO of the chemical container CC to seal the chemical container CC.

The light sensor 133 may identify the location of the equipment cap module TC. The light sensor 133 may identify a distance between the equipment cap module TC and the equipment cap gripper 130. In addition, the light sensor 133 may identify whether the equipment cap module TC and the rotary motor 132 are aligned with each other. The state where the equipment cap module TC and the rotary motor 132 are aligned with each other may refer to a state where the central axis of the power transmission unit of the equipment cap module TC and the central axis of the rotary motor 132 are present in the same horizontal coordinates.

The finger driving device 134 may drive the first and second fingers 131-1 and 131-2. The finger driving device 134 may decrease or increase an interval between the first finger 131-1 and the second finger 131-2. As an example, in the operation of separating/connecting the equipment cap module TC by the equipment cap gripper 130, the finger driving device 134 may drive the first finger 131-1 and the second finger 131-2 in the horizontal direction to decrease the interval between the first finger 131-2 and the second finger 132-2.

The finger driving device 134 may include at least one spring, a motor, a gear, a belt, or the like, for the driving as described above. Although it is only shown that the finger driving device 134 may drive the first finger 131-1 and the second finger 131-2 in the horizontal direction, the finger driving device 134 may drive the first and second fingers 131-1 and 131-2 in the vertical direction to drive the equipment cap module TC in the vertical direction. The method of driving the first and second fingers 131-1 and 131-2 by the finger driving device 134 is not limited to the above-described example.

The equipment cap gripper 130 including the above-described configurations may be stably separated from the empty container EC and may be stably connected to the full container FC in the operation of replacing the chemical container CC by the replacement robot 100.

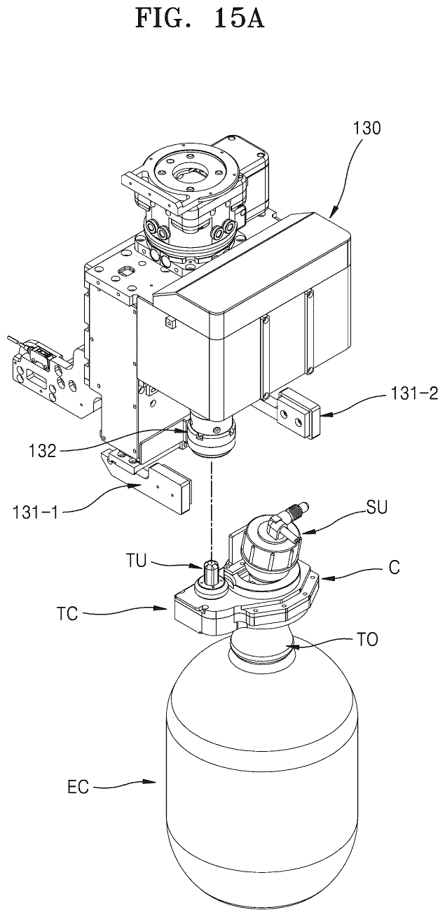

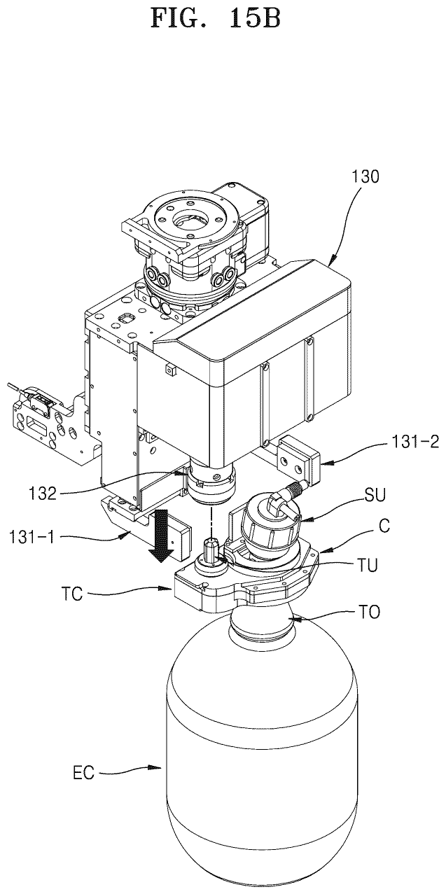

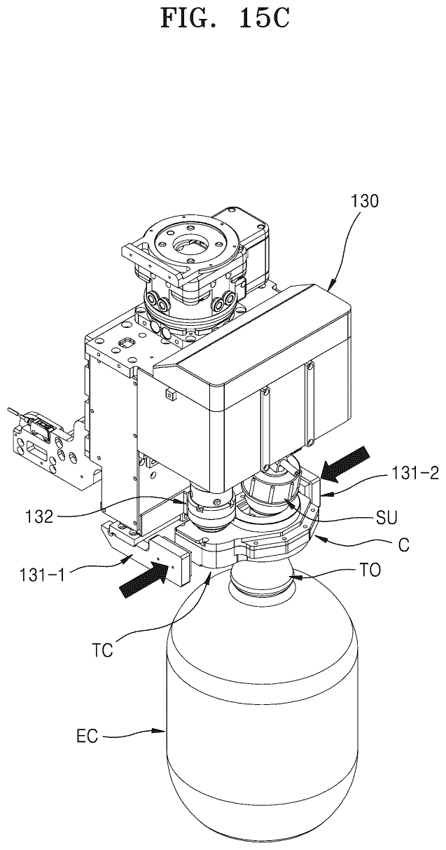

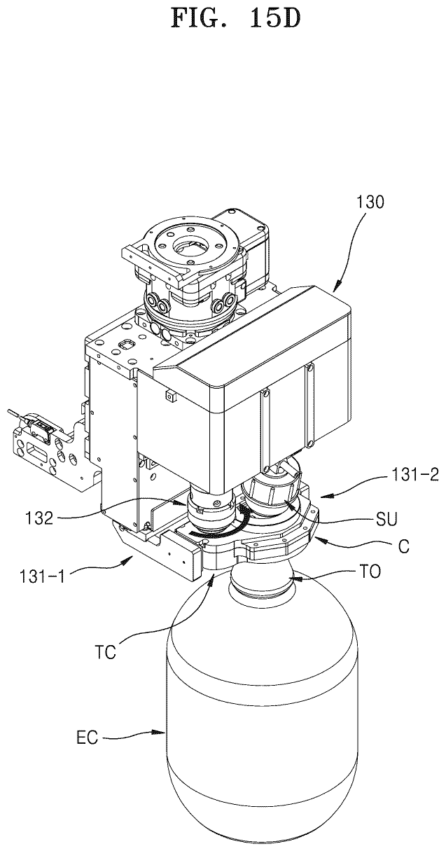

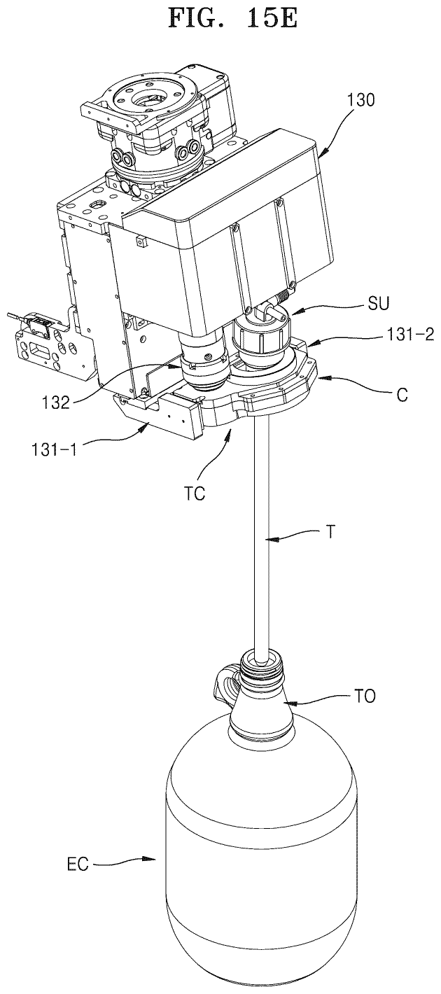

The operation of separating the equipment cap module TC from the empty container EC by the equipment cap gripper 130 is described below with reference to FIGS. 15A to 15E.

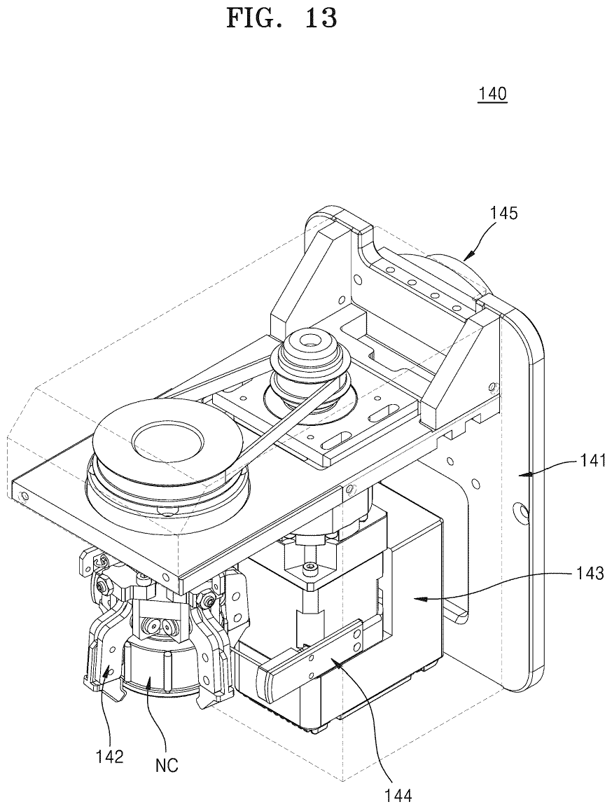

FIG. 13 is a perspective view of a return cap gripper 140 according to some example embodiments.

Referring to FIG. 13, the return cap gripper 140 may include a frame 141, a finger unit 142, a power unit 143, a cap sensor 144, and a fastening unit 145.

The frame 141 may constitute the overall exterior of the return cap gripper 140. The power unit 143 may be arranged inside the frame 141.

The finger unit 142 may grip a return cap NC. The finger unit 142 may be rotated by receiving the rotational power from the power unit 143. According to some example embodiments, as shown in FIG. 13, the finger unit 142 may include four fingers. The four fingers may be respectively connected to side surfaces of the return cap NC and may rotate in the circumferential direction with respect to the central axis of the finger unit 142. Although it is only shown that the finger unit 142 includes four fingers, this is merely an example. The finger unit 142 may include only two or three fingers or may include five or more fingers.

The return cap NC may refer to a cap connected to the upper inlet TO of the full container FC supplied by the container port 400. The return cap NC may be mounted on the full container FC that is newly supplied from the outside of the FAB to the inside of the FAB or the full container FC newly supplied to the chemical equipment EQ. The return cap NC may maintain the sealed state of the full container FC.

The power unit 143 may provide the rotational power to the finger unit 142. The power unit 143 may be arranged inside the frame 141 and may include at least one motor, a belt, a gear, and the like. The power unit 143 may provide the rotational power to the finger unit 142 so that the first and second fingers included in the finger unit 142 rotate in the circumferential direction with respect to the central axis of the finger unit 142.

The cap sensor 144 may identify whether the finger unit 142 has gripped the return cap NC. The cap sensor 144 may optically identify whether the return cap NC gripped by the finger unit 142 is present. The fastening unit 145 may be disposed on a rear surface of the frame 141. The fastening unit 145 may form a connection with the robot arm 102.

The return cap gripper 140 including the above-described configurations may stably separate the return cap NC from the full container FC in the operation of replacing the chemical container CC by the replacement robot 100.

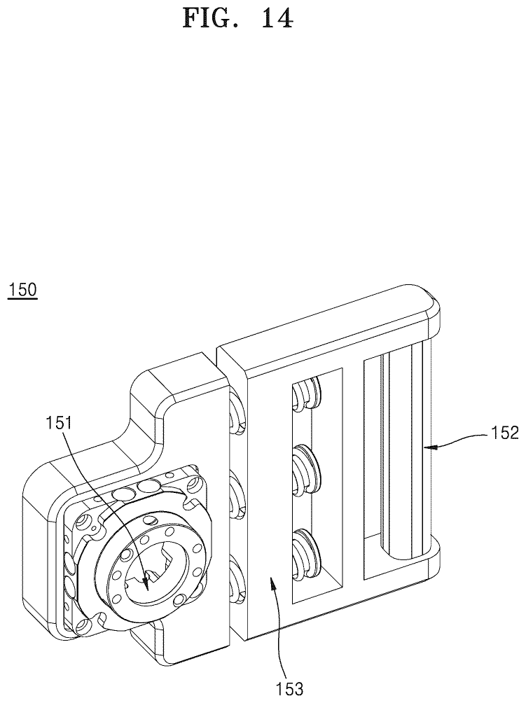

FIG. 14 is a perspective view of a door gripper 150 according to some example embodiments.

Referring to FIG. 14, the door gripper 150 may include a robot fastening unit 151, an equipment fastening unit 152, and a shock-absorbing module 153. The replacement robot 100 may control the robot arm 102 equipped with the door gripper 150 to directly open or close the cabinet device 300.

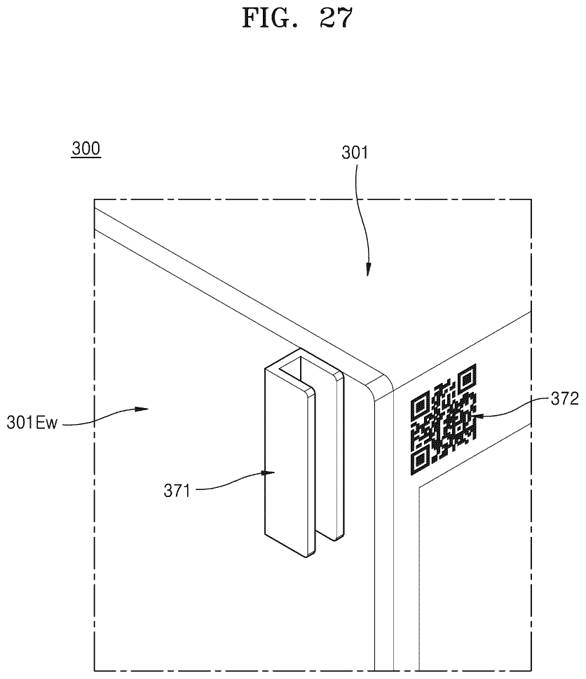

The robot fastening unit 151 may form a connection with the robot arm 102. In addition, the equipment fastening unit 152 may form a connection with a door handle 371 in FIG. 27, to be described below. The equipment fastening unit 152 may be inserted into a groove formed in the door handle 371 to form a connection with the door handle 371.

The shock-absorbing module 153 may connect the robot fastening unit 151 to the equipment fastening unit 152. The shock-absorbing module 153 may prevent or limit transmission of a shock or vibrations, which is generated when the replacement robot 100 directly opens or closes the cabinet device 300. As shown in FIG. 14, the shock-absorbing module 153 may include a plurality of springs arranged between the robot fastening unit 151 and the equipment fastening unit 152. The plurality of springs of the shock-absorbing module 153 may damp the shock or vibrations generated from the equipment fastening unit 152 so as not to be transmitted to the robot fastening unit 151. In addition, the plurality of springs of the shock-absorbing module 153 may damp the shock or vibrations generated from the robot fastening unit 151 so as not to be transmitted to the equipment fastening unit 152.

The door gripper 150 including the above-described configurations may stably form a connection with the door handle 371 of the cabinet device 300. The operation of manually opening/closing the cabinet device 300 by the replacement robot 100 and the door handle 371 of the cabinet device 300 is described below with reference to FIG. 27.

FIGS. 15A to 15E are diagrams illustrating an operation of separating the cap C by the equipment cap gripper 130, according to some example embodiments. It is assumed in FIGS. 15A to 15E that the equipment cap gripper 130 is attached to the robot arm 102 of the replacement robot 100 and the empty container EC is arranged in the first container case 112-1 of the container table 110 of the replacement robot 100.

Referring to FIG. 15A, the replacement robot 100 may control the robot arm 102 such that the equipment cap gripper 130 is arranged above the equipment cap module TC connected to the upper inlet TO of the empty container EC. In addition, the replacement robot 100 may align the rotary motor 132 of the equipment cap gripper 130 with the equipment cap module TC.

According to some example embodiments, the replacement robot 100 may control the robot arm 102 to align the rotary motor 132 with the power transmission unit TU of the equipment cap module TC. The replacement robot 100 may drive the robot arm 102 equipped with the equipment cap gripper 130 so that the central axis of the rotary motor 132 and the central axis of the power transmission unit TU are arranged at the same horizontal coordinates.

The power transmission unit TU may include a protrusion couplable with the rotary motor 132. The power transmission unit TU may be connected to a sealing unit SU of the cap C and may be positioned to transmit the rotational power to the sealing unit SU.

According to some example embodiments, the replacement robot 100 may identify whether the rotary motor 132 is aligned with the equipment cap module TC based on a sensing value of the light sensor 133 included in the equipment cap gripper 130. The light sensor 133 may sense the brightness of the reflected light, and the replacement robot 100 may identify the degree of change in the brightness of the reflection light to identify whether the rotary motor 132 is aligned with the equipment cap module TC. As shown in FIG. 15A, in a state where the first and second fingers 131-1 and 131-2 of the equipment cap gripper 130 are arranged at a higher vertical level than the equipment cap module TC, the first and second fingers 132-1 and 132-2 may be spaced apart from each other by a maximum distance.

Referring to FIG. 15B, the replacement robot 100 may control the robot arm 102 to move the equipment cap gripper 130 downward while maintaining the aligned state. In the operation of moving the equipment cap gripper 130 downward, the first and second fingers 131-1 and 131-2 may be spaced apart from each other by a maximum distance.

The replacement robot 100 may move the equipment cap gripper 130 downward to a vertical level where the rotary motor 132 is connected to the power transmission unit TU. In addition, the replacement robot 100 may move the equipment cap gripper 130 downward so that the first and second fingers 131-1 and 131-2 are arranged at the same vertical level as the equipment cap module TC.

The replacement robot 100 may identify whether the rotary motor 132 is connected to the power transmission unit TU based on the sensing value of the light sensor 133 included in the equipment cap gripper 130. When it is identified that the rotary motor 132 is connected to the power transmission unit TU, the replacement robot 100 may stop driving the equipment cap gripper 130 downward.

Referring to FIG. 15C, when the rotary motor 132 is connected to the power transmission unit TU, the replacement robot 100 may control the finger driving device 134 to connect the first finger 131-1 and the second finger 131-2 to both sides of the equipment cap module TC, respectively.

The replacement robot 100 may fix the equipment cap module TC by bringing the first finger 131-1 and the second finger 131-2 into contact with both sides of the equipment cap module TC, respectively. In some example embodiments, a friction material may be disposed on the inner walls of the first finger 131-1 and the second finger 131-2. Accordingly, the first finger 131-1 and the second finger 131-2 may stably fix the equipment cap module TC based on the frictional force caused by the contact between the first finger 131-1 and the second finger 131-2.

Referring to FIG. 15D, when the equipment cap module TC is fixed by the first finger 131-1 and the second finger 131-2, the replacement robot 100 may separate the sealing unit SU from the empty container EC.

According to some example embodiments, the replacement robot 100 may control the movement of the rotary motor 132 connected to the power transmission unit TU to provide the rotational power or torque to the power transmission unit TU. The rotary motor 132 may provide the rotational power or torque to the power transmission unit TU, and the power transmission unit TU may be rotated by the provided rotational power. In some example embodiments, the power transmission unit TU may transmit the rotational power to the sealing unit SU connected to the power transmission unit TU.

As an example, the power transmission unit TU and the sealing unit SU may include gears that mesh with each other. As the gear of the power transmission unit TU and the gear of the sealing unit SU mesh with each other, the power transmission unit TU may transmit the rotational power to the sealing unit SU. As another example, the power transmission unit TU and the sealing unit SU may be connected to each other by the belt. As the power transmission unit TU and the sealing unit SU are connected to each other by the belt, the power transmission unit TU may transmit the rotational power to the sealing unit SU. However, the aforementioned example is merely an example of the connection structure of the power transmission unit TU and the sealing unit SU. The connection structure of the power transmission unit TU and the sealing unit SU may be implemented as various types of connection structures for transmitting the rotational power.

The sealing unit SU may rotate based on the rotational power transmitted from the power transmission unit TU. As the sealing unit SU rotates, the connection between the upper inlet TO of the empty container EC and sealing unit SU may be released. In addition, the cap C may be separated from the upper inlet TO of the empty container EC.

Referring to FIG. 15E, when the cap C is separated from the upper inlet TO of the empty container EC, the replacement robot 100 may control the robot arm 102 equipped with the equipment cap gripper 130 to transfer the equipment cap module TC to the full container FC.

According to some example embodiments, the replacement robot 100 may control the movement of the robot arm 102 to lift the equipment cap module TC upward, thereby exposing the tube T of the equipment cap module TC above the upper inlet TO of the empty container EC. The replacement robot 100 may lift the equipment cap module TC upward while maintaining a state where the base end of the tube T overlaps with the upper inlet TO of the empty container EC in the vertical direction.

According to some example embodiments, when the tube T is completely exposed above the empty container EC, the replacement robot 100 may control the robot arm 102 to drive the equipment cap module TC in a rotational trajectory corresponding to the rotational trajectory of the first container case 112-1. The rotational trajectory of the first container case 112-1 may refer to a rotational trajectory of the first container case 112-1 by the case driving device 114 of FIG. 7 or a rotational trajectory of the first container case 112a-1 by the case driving device 114a of FIG. 8. However, the rotational trajectory of the first container case 112-1 is not limited to the above-described example (e.g., an example according to the description with reference to FIG. 7 or FIG. 8). The rotational trajectory of the first container case 112-1 may further include other types of rotational trajectories.

The replacement robot 100 may drive the equipment cap module TC in a rotational trajectory corresponding to the rotational trajectory of the first container case 112-1 to prevent or limit the small amount of toxic contents present in the tube T from being discharged to the outside of the empty container EC when the equipment cap module TC is moved to the full container FC.

The operation of lifting the equipment cap module TC from the empty container EC and connecting the equipment cap model TC to the full container FC by the replacement robot 100 is described with reference to FIGS. 16A to 16F.

FIGS. 16A to 16F are diagrams illustrating an operation of replacing the chemical container CC by the replacement robot 100, according to some example embodiments.

Referring to FIG. 16A, the replacement robot 100 may transfer the empty container EC from the chemical equipment EQ to the first container case 112-1. The equipment cap module TC may be connected to the empty container EC. In addition, the full container FC connected to the return cap NC may be accommodated in the second container case 112-2.

The replacement robot 100 may control the container gripper 120 mounted on the robot arm 102 to grip the empty container EC stored in the cabinet device 300. When the container gripper 120 grips the empty container EC, the replacement robot 100 may control the robot arm 102 equipped with the container gripper 120 gripping the empty container EC so as to transfer the empty container EC to the first container case 112-1.

Referring to FIG. 16B, when the empty container EC is accommodated in the first container case 112-1, the replacement robot 100 may control the first container case 112-1 such that the empty container EC is fixed and supported on the first container case 112-1.

The replacement robot 100 may identify whether the empty container EC is accommodated in the first container case 112-1 based on the sensing value of the light sensor 27 in FIG. 9 or the sensing value of the push sensor 28 in FIG. 10. The replacement robot 100 may control, based on the sensing value, the first container case 112-1 such that the empty container EC is fixed and supported on the first container case 112-1 when the empty container EC has been identified to be accommodated in the first container case 112-1.

According to some example embodiments, the replacement robot 100 may control the plurality of fixing plates 11-1 and 11-2 and the container fixing device 13 to fix the empty container EC to the first container case 112-1, as described above with reference to FIGS. 5A to 5C. According to some example embodiments, the replacement robot 100 may use the fixing structure 14 and the locking device 18 to fix the empty container EC to the first container case 112-1, as described above with reference to FIGS. 6A to 6E. When the replacement robot 100 uses the passive fixing method of FIGS. 6A to 6E described above, a separate operation of controlling the first container case 112-1 of the replacement robot 100 for fixing the empty container EC may not be performed.

Referring to FIG. 16C, the replacement robot 100 may control the equipment cap gripper 130 mounted on the robot arm 102 to separate the cap C connected to the upper inlet TO of the empty container EC accommodated in the first container case 112-1 from the empty container EC. The replacement robot 100 may separate the cap C from the empty container EC based on the method of separating the equipment cap module TC described above with reference to FIGS. 15A to 15E. The robot arm 102 may be mounted on the equipment cap gripper 130 when the replacement robot 100 performs the operation corresponding to FIG. 16C.

The replacement robot 100 may maintain alignment of the tube T and the upper inlet TO of the empty container EC and may control the movement of the robot arm 102 to vertically lift the cap C. The alignment state of the tube T and the upper inlet TO of the empty container EC may refer to a state where the small amount of the contents remaining in the tube T is not discharged to the outside of the empty container E. The alignment state of the tube T and the upper inlet TO of the empty container EC may include a state where the base end of the tube T exposed above the upper inlet TO of the empty container E overlaps with the upper inlet TO in the vertical direction. However, the alignment state of the tube T and the upper inlet TO of the empty container EC is not limited to the above-described example. The alignment state may include other types of arrangement states.

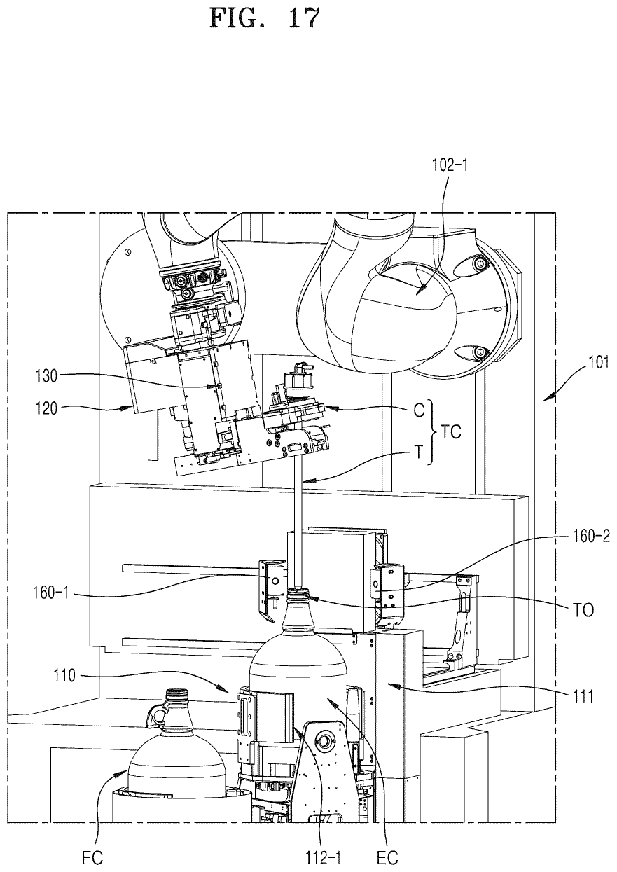

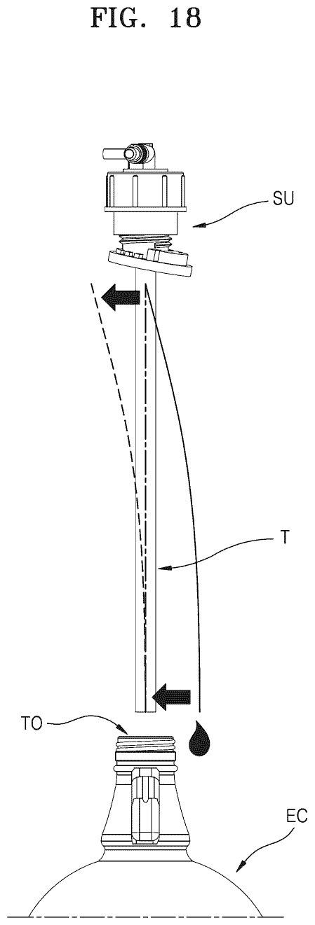

According to some example embodiments, the replacement robot 100 may obtain an alignment image obtained by photographing the tube T and the empty container EC and may maintain an alignment state of the tube T and the upper inlet TO of the empty container EC based on the alignment image. In some example embodiments, the tube T may be bent with respect to the vertical direction. In some example embodiments, the replacement robot 100 may control the movement of the robot arm 102 to correct the position error based on the alignment image, thereby maintaining the alignment state of the tube T and the upper inlet TO of the empty container EC. A method of controlling the robot arm 102 to identify and correct the position error between the tube T and the upper inlet TO based on the alignment image by the replacement robot 100 is described below with reference to FIGS. 17 and 18.

As described above, the replacement robot 100 may lift the cap C above the empty container EC while maintaining the alignment state of the tube T and the upper inlet TO, and the tube T may be exposed above the empty container EC. As an example, the base end of the tube T may be spaced upward from the upper inlet TO of the empty container EC by about 1 mm to about 2 cm.

Referring to FIG. 16D, when the equipment cap module TC is fully exposed above the empty container EC, the replacement robot 100 may control the robot arm 102 and the case driving device 114 to transfer the equipment cap module TC to the full container FC.

The replacement robot 100 may maintain the alignment state of the tube T and the upper inlet TO of the empty container EC and may control the robot arm 102 and the case driving device 114 to transfer the equipment cap module TC to the full container FC.

According to some example embodiments, the case driving device 114 may rotate the first container case 112-1 in a predetermined rotational trajectory, and the robot arm 102 may transfer the equipment cap module TC in a rotational trajectory corresponding to the predetermined rotational trajectory. The case driving device 114 may rotate the first container case 112-1 in the predetermined rotational trajectory. The predetermined rotational trajectory may refer to a rotational trajectory of the first container case 112-1 such that at least a part of the upper inlet TO of the empty container EC accommodated in the first container case 112-1 overlaps with the upper inlet TO of the full container FC accommodated in the second container case 112-2 in the vertical direction. The predetermined rotational trajectory may be determined based on a positional relationship between the first container case 112-1 and the second container case 112-2, a shape of the empty container EC, a shape of the full container FC, and a position of the case driving device 114. In addition, the predetermined rotational trajectory may include a rotational trajectory predetermined by a user (e.g., an engineer).

The replacement robot 100 may control the robot arm 102 to transfer the equipment cap module TC to the full container FC in the rotational trajectory corresponding to the predetermined rotational trajectory. The expression “the equipment cap module TC is transferred in the rotational trajectory corresponding to the predetermined rotational trajectory” may mean that “the base end of the tube T of the equipment cap module TC is rotated and transferred in the same/similar rotational trajectory as the upper inlet TO of the empty container EC”. As the equipment cap module TC is transferred to the rotational trajectory corresponding to the predetermined rotational trajectory, the alignment state of the tube T and the upper inlet TO of the empty container EC may be maintained while the equipment cap module TC is transferred to the full container FC.

The replacement robot 100 may transfer the equipment cap module TC to the full container FC while maintaining the alignment state of the tube T and the upper inlet TO of the empty container EC, thereby preventing or limiting the contents remaining in the tube T from being discharged to the outside of the empty container EC.

Referring to FIG. 16E, when the equipment cap module TC is transferred to the full container FC accommodated in the second container case 112-2, the replacement robot 100 may control the equipment cap gripper 130 to connect the equipment cap module TC to the full container FC.

The replacement robot 100 may place the sealing unit SU of the cap C on the upper inlet TO of the full container FC and drive the rotary motor 132 of the equipment cap gripper 130. The power transmission unit TU of the cap C may be rotated by driving the rotary motor 132, and the sealing unit SU of the cap C connected to the power transmission unit TU may be rotated by the rotation of the power transmission unit TU. The sealing unit SU of the cap C may be connected to the upper inlet TO of the full container FC while the sealing unit SU rotates.

In addition, the return cap NC connected to the full container FC accommodated in the second container case 112-2 may be transferred to the empty container EC, and the return cap NC may be connected to the upper inlet TO of the empty container EC. In the operation of transferring and connecting the return cap NC to the empty container EC, the replacement robot 100 may use the return cap gripper 140 attached to the robot arm 102.

Referring to FIG. 16F, the replacement robot 100 may control the robot arm 102 and the container gripper 120 mounted on the robot arm 102 to transfer the full container FC accommodated in the second container case 112-2 to the cabinet device 300.

FIG. 17 is a perspective view illustrating an operation of replacing the chemical container CC by the replacement robot 100, according to some example embodiments.

Referring to FIG. 17, the container gripper 120 and the equipment cap gripper 130 may be mounted on the first robot arm 102-1, and the container table 110 may include a plurality of cameras 160-1 and 160-2 disposed on the table body 111. The replacement robot 100 may separate the equipment cap module TC connected to the empty container EC from the empty container EC and may control the first robot arm 102-1 and the equipment cap gripper 130 mounted on the first robot arm 102-1 to lift the equipment cap module TC.

The replacement robot 100 may acquire the alignment image through the plurality of cameras 160-1 and 160-2 while lifting the equipment cap module TC. As described above, the alignment image may include an image for the tube T and the empty container EC. The replacement robot 100 may obtain a plurality of alignment images through the plurality of cameras 160-1 and 160-2, respectively. The replacement robot 100 may obtain three-dimensional (3D) distance information about the tube T and the upper inlet TO of the empty container EC based on the plurality of alignment images.

According to some example embodiments, the replacement robot 100 may identify the central axis of the tube T exposed above the empty container EC and the central axis of the upper inlet TO of the empty container EC based on the alignment images. The replacement robot 100 may identify a horizontal interval between the central axis of the tube T and the central axis of the upper inlet TO of the empty container EC as the position error.

The replacement robot 100 may control the movement of the first robot arm 102-1 to correct the position error. When the position error is “1 cm in the first horizontal direction and −2 cm in the second horizontal direction”, the replacement robot 100 may drive the first robot arm 102-1 in the first horizontal and second horizontal directions so that the central axis of the tube T is moved by “1 cm in the first horizontal direction and −2 cm in the second horizontal direction”.

Although it is only shown that the replacement robot 100 may identify the position error based on the positions of the central axis of the tube T and the central axis of the upper inlet TO of the empty container EC, the replacement robot 100 may identify the position error on the basis of various methods. For example, the replacement robot 100 may identify the position error on the basis of the positions of a right corner of the tube T and a right corner of the upper inlet TO of the empty container EC.

Although FIG. 17 only shows that the replacement robot 100 may obtain the 3D distance information of the tube T and the upper inlet TO of the empty container EC based on the first camera 160-1 and the second camera 160-2, the replacement robot 100 may also obtain the 3D distance information based on one 3D camera mounted on the table body 111.

FIG. 18 is a diagram illustrating an operation of correcting a position error by the replacement robot 100, according to some example embodiments.

Referring to FIG. 18, the tube T of the equipment cap module TC may be bent with respect to the vertical direction. When the tube T is bent and is lifted upward by the replacement robot 100, the contents remaining in the tube T may be discharged from the base end of the tube to the outside of the empty container EC.

The replacement robot 100 may maintain the alignment state of the tube T and the upper inlet TO of the empty container EC based on the method described above with reference to FIG. 17, to prevent or limit the contents remaining in the tube T from being discharged to the outside of the empty container EC.

The replacement robot 100 may identify, based on the alignment image, an edge of the tube T and an edge of the upper inlet TO of the empty container EC. The edge of the tube T and the edge of the upper inlet TO based on the alignment image may be identified based on various types of edge detection techniques. As an example, the edge detection technique may include various techniques, such as a Sobel filter-based edge detection method, a Canny edge detection method, and a CNN-based edge detection method.

According to some example embodiments, the replacement robot 100 may identify, based on the identified edge of the tube T, the central axis of the base end of the tube T. In addition, the replacement robot 100 may identify the central axis of the upper inlet TO based on the identified edge of the upper inlet TO. The replacement robot 100 may identify a horizontal interval between the central axis of the base end of the tube T and the central axis of the upper inlet TO to identify the horizontal interval as the position error.

According to some example embodiments, the replacement robot 100 may identify, based on the identified edge of the tube T, the coordinates of the right edge of the base end of the tube T. In addition, the replacement robot 100 may identify the coordinates of the right edge of the upper inlet TO based on the identified edge of the upper inlet TO. The replacement robot 100 may identify the interval between the coordinates of the right edge of the base end of the tube T and the coordinates of right edge of the upper inlet TO as the position error. The replacement robot 100 may identify the position error based on various methods in addition to the above-described method of identifying the position error based on the “central axis”or the “right edge”.

As described above, the replacement robot 100 may identify the position error between the tube T and the upper inlet TO of the empty container EC based on the alignment image of the tube T and the upper inlet TO of the empty container EC. Thus, the replacement robot 100 may lift the equipment cap module TC upward while maintaining the alignment state of the tube T and the upper inlet TO of the empty container EC.

FIG. 19 is a diagram illustrating an operation of delivering the chemical container CC by the replacement robot 100 and the return robot 200, according to some example embodiments. FIG. 19 is an enlarged view of the region A in FIG. 1.

Referring to FIG. 19, the return robot 200 may exchange the chemical container CC with the replacement robot 100.

The return robot 200 may provide the full container FC connected to the return cap NC to the replacement robot 100. In addition, the return robot 200 may receive the empty container EC connected to the return cap NC from the replacement robot 100.

The return robot 200 may include a loading area 201 for storing the chemical container CC. The loading area 201 may accommodate at least one chemical container CC. The loading area 201 may include an internal space for accommodating at least one chemical container CC. The loading area 201 may include a cover 202 that covers the top of the internal space so that the chemical container CC is not detached from the internal space. The cover 202 may be automatically opened or closed depending on whether the chemical container CC is accommodated in the loading area 201.

In addition, the return robot 200 may further include a traveling unit for traveling between the container port 400 and the replacement robot 100, and a communication interface for performing communication with the replacement robot 100, the cabinet device 300, the container port 400, and the server 500.

FIG. 20 is a diagram illustrating an operation of replacing the chemical container CC by the replacement robot 100 and the cabinet device 300 according to some example embodiments. FIG. 20 is an enlarged view of the region B in FIG. 1.

Referring to FIG. 20, the cabinet device 300 may provide the empty container EC to the replacement robot 100 and receive the full container FC from the replacement robot 100.

The cabinet device 300 may include a cabinet body 301, a cabinet loading unit 302, and a communication interface 330.

The cabinet body 301 may constitute the overall exterior of the cabinet device 300. The cabinet body 301 may be driven between the inside and the outside of the chemical equipment EQ. When the cabinet body 301 is in the closed state, the cabinet body 301 may be located inside the chemical equipment EQ, and when the cabinet body 301 is in the open state, the cabinet body 301 may be positioned outside the chemical equipment EQ.

Hereinafter, the operation of the cabinet device 300 is described by assuming that the direction in which the cabinet body 301 is driven between the inside and the outside of the chemical equipment EQ is a first horizontal direction.

The cabinet loading unit 302 may accommodate at least one chemical container CC. The chemical container CC accommodated in the cabinet loading unit 302 may be connected to the chemical equipment EQ through the equipment cap module TC. The contents of the chemical container CC accommodated in the cabinet loading unit 302 may be supplied to the chemical equipment EQ through the equipment cap module TC. The cabinet loading unit 302 may be mounted on the cabinet body 301.

The communication interface 330 may be included in the inside of the cabinet body 301. The communication interface 330 may transmit or receive various types of signals to or from the external device (e.g., replacement robot 100 and the server 500). The communication interface 330 may include a wireless communication module (e.g., an NFC module, a wireless LAN module, an IR communication module, a Zigbee communication module, a WiFi communication module, or a Bluetooth communication module). The communication interface 330 may perform wireless communication with the external device through the wireless communication module.

The cabinet device 300 may receive an open command from the replacement robot 100 or the server 500 through the communication interface 330. When the open command is received through the communication interface 330, the cabinet device 300 may drive a cabinet driving device to open the cabinet body 301. In addition, the cabinet device 300 may receive a close command from the replacement robot 100 or the server 500 through the communication interface 330. The cabinet device 300 may drive the cabinet driving device to close the cabinet body 301 when the close command is received through the communication interface 330. The operation of opening/closing the cabinet body 301 based on the cabinet driving device is described below with reference to the drawings.

In addition, the overall operation of the cabinet device 300 may be controlled by a control unit of the cabinet device 300. The control unit of the cabinet device 300 may include at least one processor and memory. The control unit of the cabinet device 300 may be implemented in hardware, firmware, software, or any combination thereof. The control unit of the cabinet device 300 may include a simple controller, a complex processor, such as a microprocessor, a CPU, a GPU, or the like, a processor configured by software, dedicated hardware, or firmware. The control unit of the cabinet device 300 may be the same as or similar in some respects to the control unit 170 of the replacement robot 100, and a description thereof is omitted herein for the sake of brevity.

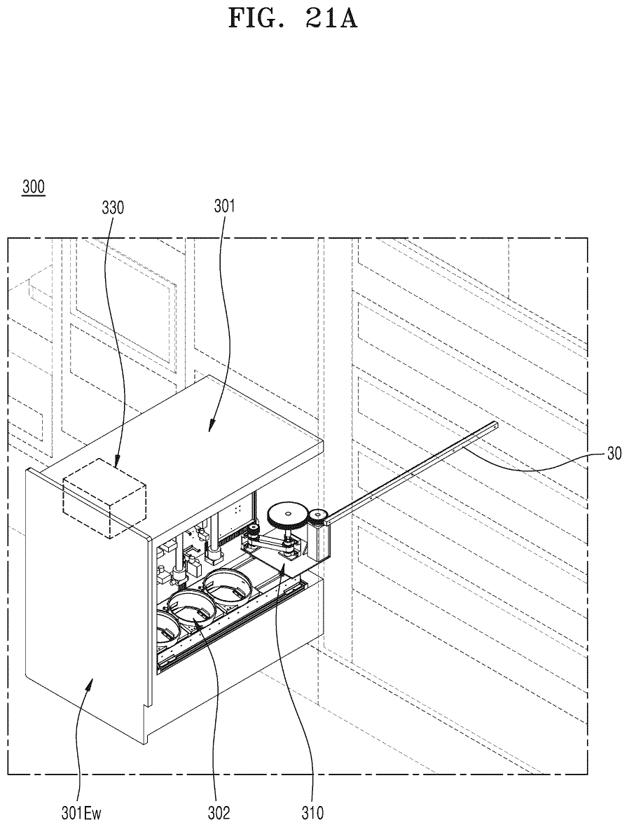

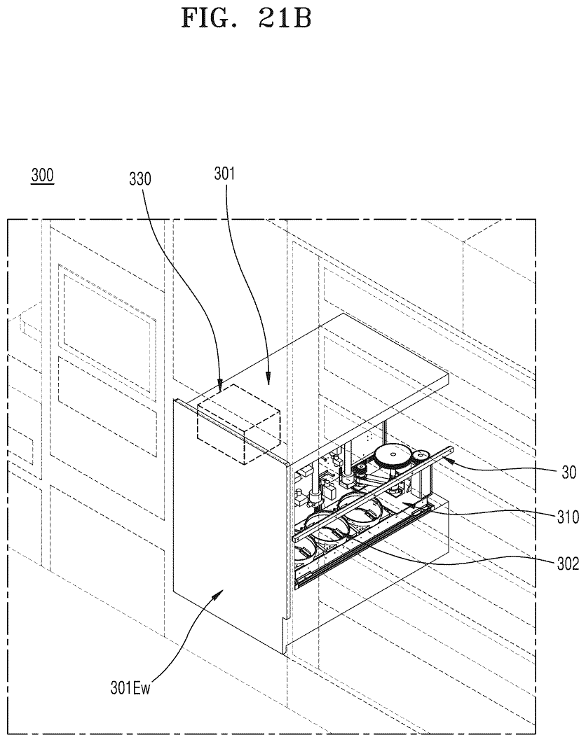

FIGS. 21A and 21B are perspective views of the cabinet device 300 according to some example embodiments.

Referring to FIG. 21A, the cabinet body 301 may be in an open state. When the cabinet body 301 is in the open state, the cabinet body 301 may be exposed to the outside of the chemical equipment EQ. Referring to FIG. 21B, the cabinet body 301 may be in the closed state. When the cabinet body 301 is in the closed state, the cabinet body 301 may be arranged inside the chemical equipment EQ, and only an outer wall 301Ew of the cabinet body 301 may be exposed to the outside of the chemical equipment EQ. A cabinet driving device 310 may drive the cabinet body 301 in the first horizontal direction, so that the cabinet body 301 may be arranged in the open state or the closed state.

According to some example embodiments, the cabinet driving device 310 may move in the first horizontal direction along an equipment rack 30 fixed to the chemical equipment EQ.

The equipment rack 30 may be fixed to the inside of the chemical equipment EQ and may include a rack gear elongated in the first horizontal direction. The equipment rack 30 may be arranged at a vertical level corresponding to the vertical level at which the cabinet driving device 310 is arranged. For example, when the cabinet driving device 310 and the cabinet loading unit 302 are arranged at an intermediate vertical level of the cabinet body 301, the equipment rack 30 may be arranged at the intermediate vertical level of the cabinet body 301. However, the equipment rack 30 may be arranged at an upper vertical level of the cabinet body 301, a lower vertical level of the cabinet body 301, and the like. Thus, the vertical level at which the equipment rack 30 is installed is not limited to the aforementioned example.

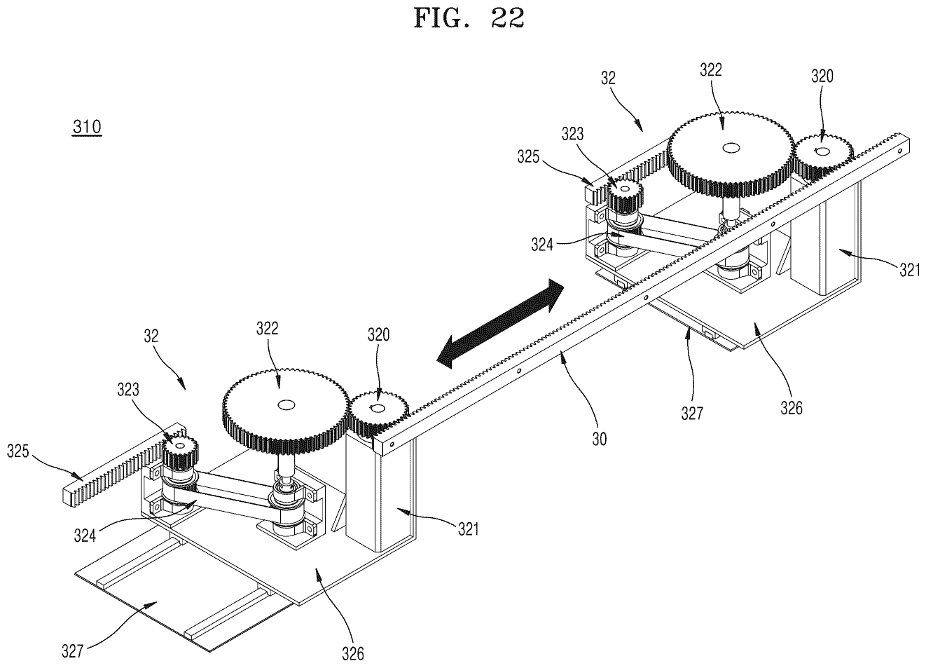

The cabinet driving device 310 may be mounted on the cabinet body 301 and may be arranged adjacent to the cabinet loading unit 302. As shown in FIG. 21A, the cabinet driving device 310 may be arranged at the same vertical level as the cabinet loading unit 302 on which the chemical container CC is loaded and may be disposed on a side of the cabinet loading unit 302. A sliding guide (327 in FIG. 22) of the cabinet driving device 310 may be in contact with the cabinet loading unit 302. In addition, as shown in FIG. 21B, when the cabinet body 301 is in the closed state, a sliding member (326 in FIG. 22) may also be in contact with the cabinet loading unit 302.

The cabinet driving device 310 may be arranged adjacent to the cabinet loading unit 302 in the cabinet body 301 and may be arranged relatively inside the cabinet loading unit 302. In other words, while the cabinet loading unit 302 is arranged adjacent to the outer wall 301Ew of the cabinet body 301, the cabinet driving device 310 may be arranged further away from the outer wall 301Ew of the cabinet body 301 than the cabinet loading unit 302. As shown in FIG. 21A, when the cabinet body 301 is in the open state, the cabinet loading unit 302 may be exposed to the outside of the chemical equipment EQ and the cabinet driving device 310 may be arranged inside the chemical equipment EQ without being exposed to the outside of the chemical equipment EQ.

The cabinet driving device 310 including the sliding member (326 in FIG. 22) driven in a direction opposite to the driving direction (first horizontal direction) of the cabinet body 301 may not be exposed to the outside of the chemical equipment EQ even when the cabinet body 301 is in the open state. Since the cabinet driving device 310 is not exposed to the outside of the chemical equipment EQ even when the cabinet body 301 is in the open state, the possibility of the cabinet driving device 310 being exposed to external impact may be reduced. Accordingly, the stable movement of the cabinet driving device 310 may be obtained and the cabinet body 301 may be stably driven between the open state and the closed state. A specific configuration and operation of the cabinet driving device 310 according to some example embodiments is described below with reference to FIG. 22.

FIG. 22 is a perspective view of the cabinet driving device 310 according to some example embodiments. FIG. 22 is an enlarged view of the cabinet driving device 310 and the equipment rack 30 of FIGS. 21A and 21B.

Referring to FIG. 22, the cabinet driving device 310 may include an equipment pinion 320, a cabinet driving module 321, a cabinet rack 325, a cabinet gear module 32, a sliding member 326, and a sliding guide 327.

The equipment pinion 320 may include a pinion gear connected to the equipment rack 30. The equipment pinion 320 may include a circular gear and may mesh with the equipment rack 30. The equipment pinion 320 may rotate along the equipment rack 30, and by means of the meshing structure of the equipment pinion 320 and the equipment rack 30, the rotational motion of the equipment pinion 320 may be converted into a linear motion. The equipment pinion 320 may move in the first horizontal direction while rotating along the equipment rack 30 fixedly disposed on the chemical equipment EQ. The equipment pinion 320 may be connected to the cabinet driving module 321.

The cabinet driving module 321 may provide the rotational power to the equipment pinion 320. The cabinet driving module 321 may be connected to the equipment pinion 320. The cabinet driving module 321 may be fixedly disposed on the sliding member 326. In other words, the cabinet driving module 321 may be integrated with the sliding member 326 and may be driven together with the sliding member 326. For example, the cabinet driving module 321 may be fixedly disposed on the top surface of the sliding member 326. As described above with reference to FIGS. 21A and 21B, the cabinet driving module 321 may be arranged inside the chemical equipment EQ when the cabinet body 301 is in the open state. Accordingly, the cabinet driving module 321 may not be exposed to the external impact. In addition, since the cabinet driving module 321 does not have to be exposed to the outside of the chemical equipment EQ, the equipment rack 30 may not protrude to the outside of chemical equipment EQ. Accordingly, it may not be required to provide a separate space for driving the cabinet device 300 inside the chemical equipment EQ, thereby avoiding an increase in the area occupied by the chemical equipment EQ.

As an example, the cabinet driving module 321 may include at least one rotary motor and a housing for protecting the rotary motor. In some example embodiments, the equipment pinion 320 may be connected to a shaft of the rotary motor of the cabinet driving module 321, and the equipment pinion 320 may be provided with the rotational power from the shaft of the rotating motor of the cabinet driving module 321.

The cabinet rack 325 may be fixedly disposed on the cabinet body 301. The cabinet rack 325 may include a rack gear arranged to extend long in the first horizontal direction. The first horizontal length of the cabinet rack 325 may be less than the first horizontal length of the equipment rack 30. The cabinet rack 325 may be connected to the cabinet gear module 32.

The cabinet gear module 32 may be connected to the equipment pinion 320 and the cabinet rack 325. In addition, the cabinet gear module 32 may be fixedly disposed on the top surface of the sliding member 326 and may be integrally formed with the sliding member 326 so that the cabinet gear module 32 is driven together with the sliding member 326.

The cabinet gear module 32 may include a first cabinet pinion 322 connected to the equipment pinion 320 and a second cabinet pinion 323 connected to the cabinet rack 325. The first cabinet pinion 322 and the second cabinet pinion 323 may include circular gears. The first cabinet pinion 322 may include a circular gear that meshes with the equipment pinion 320, and the second cabinet pinion 323 may include a circular gear that meshes with the cabinet rack 325.

As shown in FIG. 22, the first cabinet pinion 322 and the second cabinet pinion 323 may be connected by a belt 324. The belt 324 may transmit the rotational motion of the first cabinet pinion 322 to the second cabinet pinion 323. However, this is only an example of a connection structure of the first cabinet pinion 322 and the second cabinet pinion 323, and the first cabinet pinion 322 and the second cabinet pinion 323 may be directly connected to each other. The gear of the first cabinet pinion 322 and the gear of the second cabinet pinion 323 are arranged at the same vertical level, and the gear of the first cabinet pinion 322 may directly mesh with the gear of the second cabinet pinion 323.

Although FIG. 22 only shows that the cabinet gear module 32 includes two cabinet pinions, this is merely an example. The cabinet gear module 32 may include four or six cabinet pinions.

The sliding member 326 may be implemented as a planar plate. The cabinet driving module 321 of cabinet gear module 32 may be fixed to the top surface of the sliding member 326. A connection member connected to the sliding guide 327 may be disposed on a bottom surface of the sliding member 326. The sliding member 326 may be connected to the sliding guide 327 through the connection member disposed on the bottom surface of the sliding member 326. The sliding member 326 may include a member driven in a direction opposite to the driving direction of the cabinet body 301.

As an example, when the cabinet body 301 is driven from the open state to the closed state, the sliding member 326 may be driven in a direction away from the chemical equipment EQ along the sliding guide 327. In addition, when the cabinet body 301 is driven from the closed state to the open state, the sliding member 326 may be driven in a direction approaching the chemical equipment EQ along the sliding guide 327.

The cabinet driving device 310 including the above configurations may drive the cabinet body 301 between the open state and the closed state. In particular, since the sliding member 326 slides with respect to the sliding guide 327 in a direction opposite to the driving direction of the cabinet body 301, the driving distance of the cabinet body 301 in the first horizontal direction may be greater than the driving distance of the equipment pinion 320 in the first horizontal direction.

According to some example embodiments, a ratio of the sliding distance between the sliding member 326 and the sliding guide 327 to the driving distance of the cabinet body 301 may be determined based on a gear ratio of the equipment pinion 320 and the cabinet gear module 32. When the cabinet gear module 32 includes the first cabinet pinion 322 and the second cabinet pinion 323, the ratio of the sliding distance of the sliding member 326 to the driving distance of the cabinet body 301 may be determined based on the number of gears of the equipment pinion 320, the first cabinet pinion 322, and the second cabinet pinion 323.

The equipment pinion 320 and the first cabinet pinion 322 may be connected to each other to transmit the rotational motion. In addition, the first cabinet pinion 322 and the second cabinet pinion 323 may be connected to each other to transmit the rotational motion. When the equipment pinion 320 rotates in the first rotational direction (e.g., counterclockwise), the first cabinet pinion 322 may rotate in a second rotational direction (e.g., clockwise) opposite to the first rotational direction, and the second cabinet pinion 323 may rotate in the first rotational direction.

As shown in FIG. 22, the number of gears of the first cabinet pinion 322 may be greater than the number of gears of the equipment pinion 320, and the number of gears of the first cabinet pinion 322 may be greater than the number of gears of the second cabinet pinion 323. In addition, the number of gears of the second cabinet pinion 323 may be less than the number of gears of the equipment pinion 320. The cabinet driving device 310 may drive the cabinet body 301 to the open state or the closed state while maintaining the ratio of the driving distance of the cabinet body 301 to the sliding distance of the sliding member 326 to be constant.

As an example, the ratio of the driving distance of the cabinet body 301 to the sliding distance of the sliding member 326 may be 10:3. In some example embodiments, while the cabinet body 301 is driven by 100 cm in the first horizontal direction, the sliding member 326 may be driven by 30 cm in a direction opposite to the driving direction of the cabinet body 301, with respect to the sliding guide 327.

The cabinet driving module 321 may provide the rotational power to the equipment pinion 320, and the equipment pinion 320 may rotate along the equipment rack 30 based on the provided rotational power. As the rotational motion of the equipment pinion 320 is converted into the linear motion of the cabinet body 301 in the first horizontal direction, the cabinet body 301 may be driven in the first horizontal direction. As the cabinet body 301 is driven in the first horizontal direction, the cabinet rack 325, the sliding member 326, and the sliding guide 327 may also be driven in the first horizontal direction. In some example embodiments, the sliding guide 327 and the cabinet rack 325 fixed to the cabinet body 301 are driven at the same speed as that of the cabinet body 301, while the sliding member 326 driven at a slower speed than that of the cabinet body 301 may slide against the sliding guide 327. This is because the second cabinet pinion 323 fixed to the top surface of the sliding member 326 may receive the rotational motion from the equipment pinion 320 and the first cabinet pinion 322 and may be rotated in the same rotational direction as the equipment pinion 320. As the second cabinet pinion 323 is rotated along the cabinet rack 325 and the rotational motion of the second cabinet pinion 223 is converted into the sliding motion of the sliding member 326, the sliding member 326 may slide in a direction opposite to the driving direction of the cabinet body 301 with respect to the sliding guide 327.

According to some example embodiments, the second cabinet pinion 323 may be driven from one end of the cabinet rack 325 to another end of the cabinet rack 325. In the open state of the cabinet body 301, the second cabinet pinion 323 may be arranged at an inner end of the cabinet rack 325. In addition, when the cabinet body 301 is in the closed state, the second cabinet pinion 323 may be arranged at an outer end of the cabinet rack 325. The inner end of the cabinet rack 325 may refer to an end of the cabinet rack 325 arranged adjacent to the inside of the chemical equipment EQ, and the outer end of the cabinet rack 325 may refer to an end of the cabinet rack 325 arranged adjacent to the outside of the chemical equipment EQ.

The rotational direction of the equipment pinion 320 may be determined according to the type of the operation of the cabinet device 300. As an example, when the cabinet device 300 receives the open command from the external device (e.g., the server 500 or the replacement robot 100) through the communication interface 330, the equipment pinion 320 may be rotated in the first rotational direction (e.g., counterclockwise) to open the cabinet body 301. Conversely, when the cabinet device 300 receives the close command from the external device through the communication interface 330, the equipment pinion 320 may be rotated in the second rotational direction (e.g., clockwise) to close the cabinet body 301.

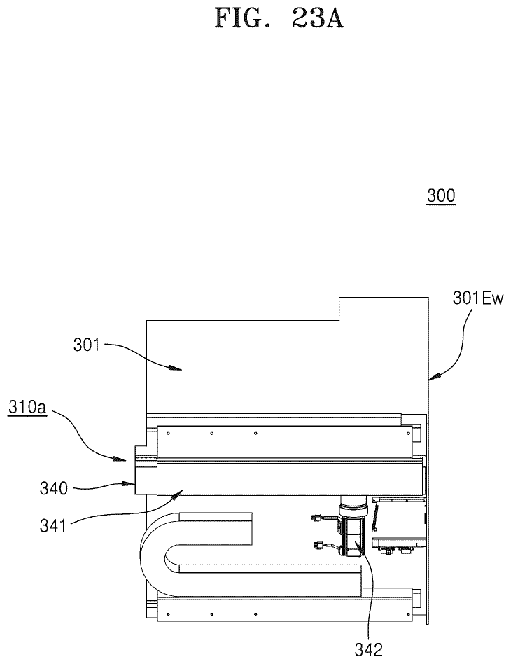

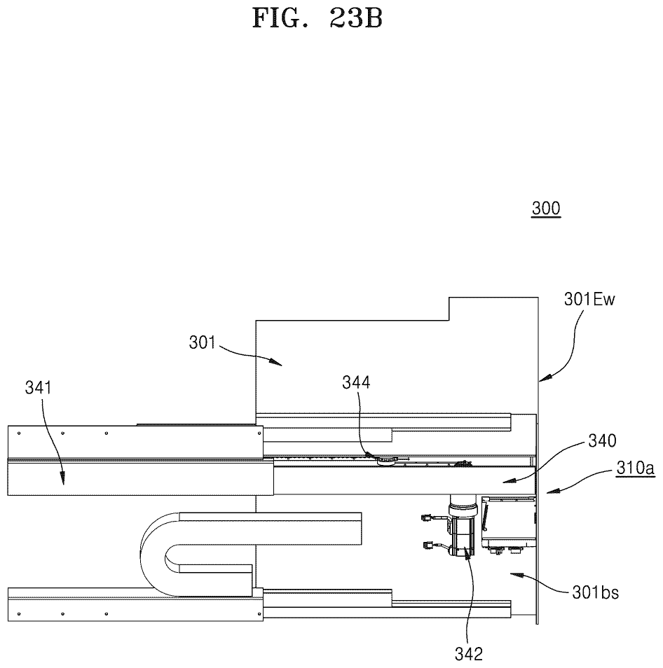

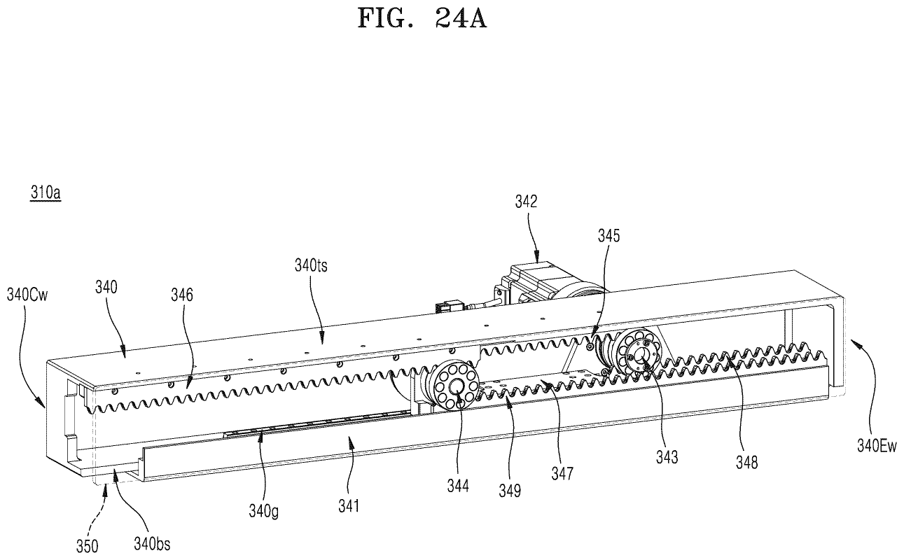

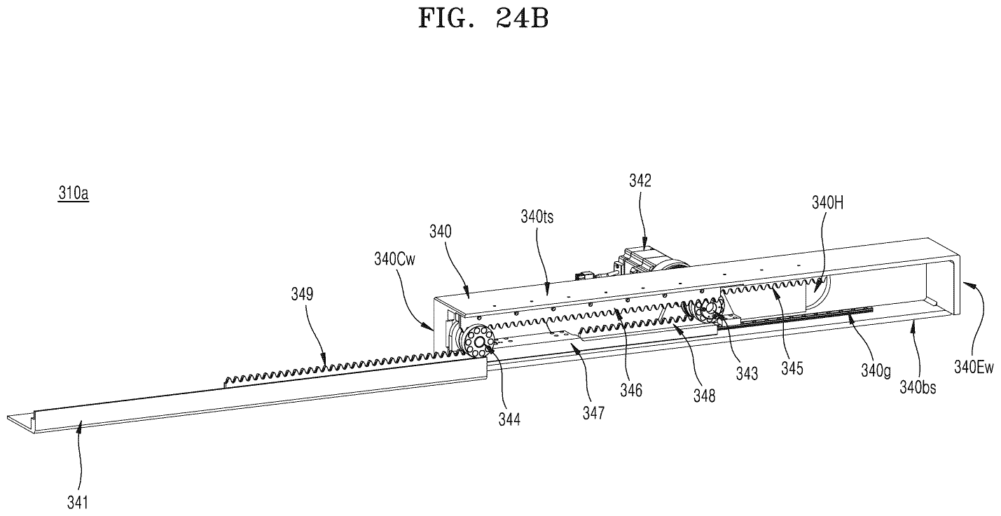

As described above, the cabinet driving device 310 including the sliding member 326 that slides in a direction opposite to the driving direction of the cabinet body 301 may be arranged inside the chemical equipment EQ even when the cabinet body 301 is in the open state. Accordingly, the possibility of the cabinet driving device 310 being exposed to external impact may be reduced. In addition, since the cabinet driving device 310 is always arranged inside the chemical equipment EQ, the equipment rack 30 may not protrude outside the chemical equipment EQ, thereby preventing or limiting the area occupied by the chemical equipment EQ itself from increasing. According to some example embodiments, a cabinet driving device which may be disposed on the bottom surface of the cabinet body 301 is described below with reference to FIGS. 23A to 24B.

FIGS. 23A and 23B are perspective views of the cabinet device 300 according to some example embodiments.

Referring to FIGS. 23A and 23B, a cabinet driving device 310a may be disposed on a bottom surface 301bs of the cabinet body 301.

The cabinet driving device 310a may include a first-stage telescopic module and a second-stage telescopic module that are arranged to be driven in the first horizontal direction, thereby driving the cabinet body 301 in the open state or the closed state. Telescopic modules refer to components that can be extended or shortened in the horizontal direction. The telescopic modules may be arranged to slide while overlapping with each other so that they can be extended or shortened in the horizontal direction.

Referring to FIG. 23A, the cabinet body 301 may be in the closed state. When the cabinet body 301 is in the closed state, the frame 340 and an equipment-side fixing member 341 may overlap with each other. The frame 340 may be connected to and fixed to the bottom surface 301bs of the cabinet body 301. The components of the first-stage telescopic module and the second-stage telescopic module may be included inside the frame 340. The equipment-side fixing member 341 may be fixed to the bottom surface of the chemical equipment EQ.

Referring to FIG. 23B, the cabinet body 301 may be in the open state. When the cabinet body 301 is in the open state, the frame 340 may be slid in the first horizontal direction with respect to the equipment-side fixing member 341. In some example embodiments, the frame 340 may not overlap with the equipment-side fixing member 341 or only a part of the frame 340 may overlap with the equipment-side fixing member 341.

The cabinet driving device 310a may include a cabinet driving module 342 disposed on the bottom surface 301bs of the cabinet body 301 and a second pinion 344 arranged inside the frame 340. The cabinet driving module 342, the second pinion 344, and the cabinet driving device 310a are described below with reference to FIGS. 24A and 24B.

As shown in FIGS. 23A and 23B, the cabinet driving device 310a may be arranged in a space between the bottom surface 301bs of the cabinet body 301 and the bottom surface of the chemical equipment EQ. Therefore, when the cabinet body 301 is in the open state, the cabinet driving device 310a may be obscured by the cabinet body 301 and may not protrude outside the cabinet body 301. Accordingly, the cabinet driving device 310a may not obstruct the passage of the replacement robot 100, the return robot 200, or workers inside the FAB, and may be less likely to be exposed to external impact.

FIGS. 24A and 24B are perspective views of the cabinet driving device 310a according to some example embodiments.

FIG. 24A illustrates a state of the cabinet driving device 310a when the cabinet body 301 is in the closed state, and FIG. 24B illustrates a state of the cabinet driving device 310a when the cabinet body 301 is in the open state.

Referring to FIGS. 24A and 24B, the cabinet driving device 310a may include the frame 340, the cabinet driving module 342, the first pinion 343, the second pinion 344, an intermediate structure 347, and a cover 350.

The frame 340 may be arranged between the bottom surface 301bs of the cabinet body 301 and the bottom surface of the chemical equipment EQ. The frame 340 may include a certain space therein. The first pinion 343 and the second pinion 344 may be arranged inside the frame 340.

A top surface 340ts of the frame 340 may be connected to and fixed to the bottom surface 301bs of the cabinet body 301. In addition, an outer wall 340Ew of the frame 340 may be connected to and fixed to the outer wall 301Ew of the cabinet body 301. The outer wall 340Ew of the frame 340 may refer to one of the sidewalls of the frame 340 arranged outside the chemical equipment EQ.

As shown in FIG. 24B, a connection hole 340H may be formed in a connection sidewall 340Cw of the frame 340. A part of the cabinet driving module 342 may be inserted into the frame 340 through the connection hole 340H. A width of the connection hole 340H in the first horizontal direction may be greater than a movement distance of the first pinion 343 connected to the cabinet driving module 342 in the first horizontal direction.

A first upper rack 345 and a second upper rack 346 may be arranged inside the top surface 340ts of the frame 340. The first upper rack 345 and the second upper rack 346 may include gears protruding from the top surface 340ts of the frame 340 toward a bottom surface 340bs of the frame 340. The first upper rack 345 may include a rack gear meshing with the first pinion 343 and the second upper rack 346 may include a rack gear meshing with the second pinion 344. The first upper rack 345 and the second upper rack 346 fixed to the inside of the top surface 340ts of the frame 340 may be driven together with the driving of the frame 340.

The first upper rack 345 may be arranged adjacent to the outer wall 301Ew of the cabinet body 301 and the outer wall 340Ew of the frame 340, compared to the second upper rack 346. In addition, the first upper rack 345 may be shorter than the second upper rack 346. In other words, the first horizontal width of the first upper rack 345 may be less than the first horizontal width the second upper rack 346. The second upper rack 346 may be formed from an end of the frame 340 to a center of the frame 340. The end of the frame 340 on which the second upper rack 346 is formed may include an end arranged at a position opposite to the outer wall 340Ew of the frame 340.

The cabinet driving module 342 may provide the rotational power to the first pinion 343. The first pinion 343 may rotate based on the provided rotational power. The cabinet driving module 342 may be connected to the first pinion 343. As an example, the cabinet driving module 342 may include at least one rotary motor and a housing that protects the rotary motor. In some example embodiments, the first pinion 343 may be connected to the shaft of the rotary motor of the cabinet driving module 342, and the first pinion 343 may be provided with the rotational power from the shaft of the rotating motor of the cabinet driving module 342.

The first pinion 343 may include a circular gear meshing with the first upper rack 345 and a first lower rack 348, and the second pinion 344 may include a circular gear meshing with the second upper rack 346 and a second lower rack 349. The first pinion 343 may be connected to the cabinet driving module 342, while the second pinion 344 may be included in the intermediate structure 347. The first pinion 343 and the second pinion 344 may be spaced at the same distance from the bottom surface 340bs of the frame 340 and may be spaced at the same distance from the top surface 340ts of the frame 340. In addition, the second pinion 344 may be spaced apart from the connection sidewall 340Cw of the frame 340, compared to the first pinion 343. The first pinion 343 may be arranged adjacent to the outer wall 340Ew of the frame 340, compared to the second pinion 344.

The intermediate structure 347 may be disposed on the bottom surface 340bs of the frame 340. The intermediate structure 347 may be arranged to be driven in the first horizontal direction with respect to the frame 340. As an example, the intermediate structure 347 may be arranged to be driven in the first horizontal direction along a sliding guide 340g fixed to the bottom surface 340bs of the frame 340. The sliding guide 340g may extend long from the bottom surface 340bs of the frame 340 in the first horizontal direction.

The driving direction of the intermediate structure 347 with respect to the frame 340 may include a direction opposite to the driving direction of the frame 340 (or the driving direction of the cabinet body 301). When the cabinet body 301 is changed from the open state to the closed state, the frame 340 may be driven from the outside of the chemical equipment EQ to the inside of the chemical equipment EQ. In contrast, the intermediate structure 347 may be driven toward the outer wall 340Ew of the frame 340. When the cabinet body 301 is in the open state, as shown in FIG. 24B, the intermediate structure 347 may be spaced apart from the outer wall 340Ew of the frame 340 by a maximum distance. On the other hand, when the cabinet body 301 is in the closed state, as shown in FIG. 24A, the intermediate structure 347 may be in contact with the outer wall 340Ew of the frame 340.

The intermediate structure 347 may include the first lower rack 348 and the second pinion 344. The first lower rack 348 may include a gear that protrudes from the top surface of the intermediate structure 347 toward the top surface 340ts of the frame 340. The first lower rack 348 may be formed from an end of the intermediate structure 347 to a center of the intermediate structure 347. The end of the intermediate structure 347 on which the first lower rack 348 is formed may include an end adjacent to the outer wall 340Ew of the frame 340. The second pinion 344 may be arranged at the other end of the intermediate structure 347. The other end of the intermediate structure 347 on which the second pinion 344 is arranged may include an end spaced apart from the outer wall 340Ew of the frame 340.

The intermediate structure 347 may be driven in a direction opposite to the driving direction of the frame 340 with respect to the frame 340 by the linear motion of the first lower rack 348 and the rotational motion of the second pinion 344.

The second lower rack 349 may include a gear protruding from the top surface of the equipment-side fixing member 341. The second lower rack 349 may be formed from an end of the equipment-side fixing member 341 to a center of the equipment-side fixing member 341. The end of the equipment-side fixing member 341 on which the second lower rack 349 is formed may include an end adjacent to the outer wall 340Ew of the frame 340.

The first lower rack 348 may be arranged adjacent to the outer wall 340Ew of the frame 340 or the outer wall 301Ew of the cabinet body 301, compared to the second lower rack 349. In addition, the first lower rack 348 may be shorter than the second lower rack 349. In other words, the first horizontal width of the first lower rack 348 may be less than the first horizontal width of the second lower rack 349.

The cover 350 may surround the frame 340 such that the first pinion 343 and the second pinion 344 are not exposed to the outside of the frame 340. The cover 350 may be implemented as a planar plate. The cover 350 may be arranged at a position opposite to the connection sidewall 340Cw of the frame 340. The cover 350 may include a transparent material.

According to some example embodiments, the first pinion 343, the first upper rack 345, and the first lower rack 348 may constitute a first telescopic module, and the second pinion 344, the second upper rack 346, and the second lower rack 349 may constitute a second telescopic module. According to the relative motion of the first telescopic module and the second telescopic module, the cabinet body 301 may be driven in the first horizontal direction.

In the opening operation of the cabinet body 301, the first pinion 343 may rotate in the first rotational direction (e.g., clockwise) based on the rotational power received from the cabinet driving module 342. By the rotational motion of the first pinion 343, the frame 340 connected to the first upper rack 345 and the intermediate structure 347 connected to the first lower rack 348 may perform linear motions in different directions. For example, the frame 340 may perform the linear motion in an outward direction of the chemical equipment EQ and the intermediate structure 347 may perform the linear motion in an inward direction of the chemical equipment EQ.

As the frame 340 and the intermediate structure 347 perform the linear motion by the rotational motion of the first pinion 343, the second upper rack 346 disposed on the top surface 340ts of the frame 340 and the second pinion 344 disposed on the intermediate structure 347 may also be driven. As the second upper rack 346 performs the linear motion in the outward direction of the chemical equipment EQ and the intermediate structure 347 performs the linear motion in the inward direction of the chemical equipment EQ, the rotational motion of the second pinion 344 may be performed at a higher speed than that of the first pinion 343.

According to some example embodiments, the rotational speed of the second pinion 344 may be about twice the rotational speed of the first pinion 343. The driving distance of the second pinion 344 may be about twice the rotational motion speed of the first pinion 343. For example, when the first pinion 343 is driven by 40 cm (or about 40 cm) in the first horizontal direction in the opening operation of the cabinet body 301 or the closing operation of the cabinet body 301, the second pinion 344 may be driven by 80 cm (or about 80 cm) in the same direction as the driving direction of the first pinion 343. In some example embodiments, the cabinet body 301 may be driven in the first horizontal direction by 120 cm (or about 120 cm) in the opening operation or the closing operation of the cabinet body 301.

In addition, as shown in FIG. 24A, the second pinion 344 may be arranged at the center of the frame 340 when the cabinet body 301 is in the closed state. On the other hand, as shown in FIG. 24B, when the cabinet body 301 is in the open state, the second pinion 344 may be arranged at one end of the frame 340. the end of the frame 340 where the second pinion 344 is located may include an end arranged at a position opposite to the outer wall 340Ew of the frame 340.

The cabinet driving device 310a may include configurations as described above, thereby automatically opening/closing the cabinet body 301. As an example, when the open command is received from the external device (e.g., the server 500 and/or the replacement robot 100) through the communication interface 330, the cabinet device 300 may rotate the first pinion 343 in the first rotational direction (e.g., clockwise) to open the cabinet body 301. Conversely, when the close command is received from the external device through the communication interface 330, the cabinet device 300 may rotate the first pinion 343 in the second rotational direction (e.g., counterclockwise) to close the cabinet body 301.

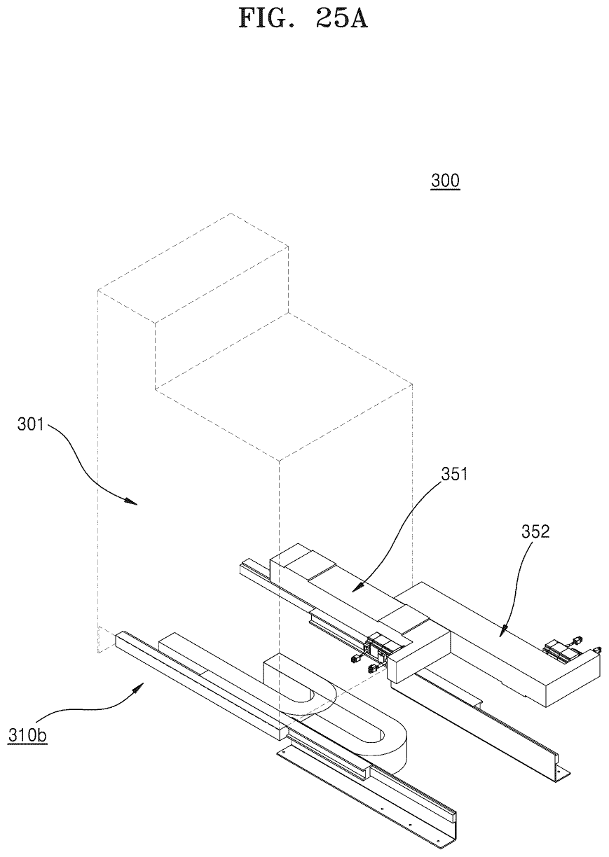

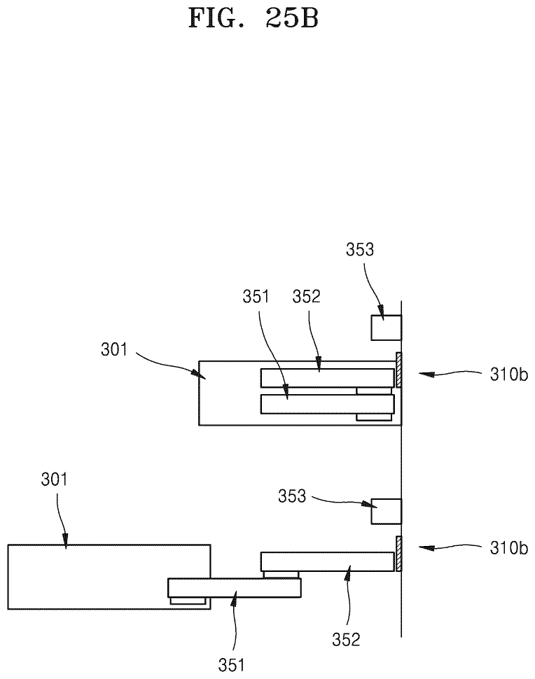

As described above, the cabinet driving device 310a may be arranged between the bottom surface 301bs of the cabinet body 301 and the bottom surface of the chemical equipment EQ. Thus, the cabinet driving device 310a may stably operate without being exposed to the external impact. A cabinet driving device based on a plurality of direct telescopic modules is briefly described below with reference to FIGS. 25A and 25B.

FIGS. 25A and 25B are perspective views of a cabinet driving device 310b according to some example embodiments.

Referring to FIGS. 25A and 25B, the cabinet driving device 310b may include a first direct telescopic module 351, a second direct telescopic module 352, and a controller 353.

Each of the first direct telescopic module 351 and the second direct telescopic module 352 may include telescopic modules that perform the linear motion independent of each other. The first direct telescopic module 351 and the second direct telescopic module 352 may perform the linear motion that extends or shortens in the first horizontal direction. One end of the first direct telescopic module 351 may be connected and fixed to the cabinet body 301, and the other end of the first direct telescopic module 351 may be connected and fixed to one end of the second direct telescopic module 352. One end of the second direct telescopic module 352 may be connected and fixed to the chemical equipment EQ, and the other end of the second direct telescopic module 352 may be connected and fixed to one end of the first direct telescopic module 351.

Each of the first direct telescopic module 351 and the second direct telescopic module 352 may include configurations for the linear motion, such as a motor, a linear motion (LM) guide, a ball screw, and the like.

The controller 353 may control the linear motion of each of the first direct telescopic module 351 and the second direct telescopic module 352. As an example, in the open operation of the cabinet body 301, the controller 353 may control the first direct telescopic module 351 and the second direct telescopic module 352 to perform the linear motion extending in the first horizontal direction. As another example, in the closed operation of the cabinet body 301, the controller 353 may control the first direct telescopic module 351 and the second direct telescopic module 352 to perform the linear motion shortened in the first horizontal direction.

As shown in FIG. 25A and FIG. 25B, the cabinet driving device 310b may be attached to the bottom surface of the cabinet body 301 to drive the cabinet body 301 in the first horizontal direction, and the cabinet driving device 310b may not protrude outside the cabinet body 301.

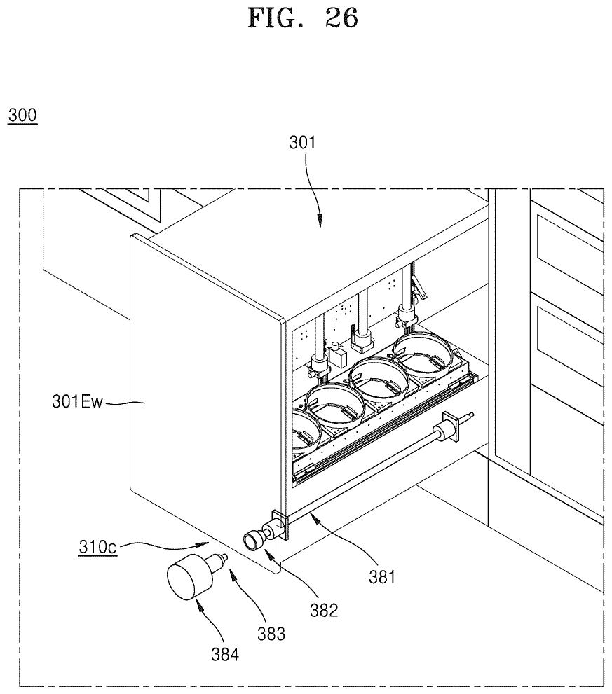

FIG. 26 is a perspective view of the cabinet device 300 according to some example embodiments.

Referring to FIG. 26, a cabinet driving device 310c may include a screw device 381, a socket 382, a shaft 383, and a connecting frame 384.

The screw device 381 may be arranged inside the cabinet body 301. The screw device 381 may include a spiral rod (or a rod having screw threads). As the screw device 381 rotates, the cabinet body 301 may be driven in the first horizontal direction.

The socket 382 may be connected to one end of the screw device 381. The socket 382 may transmit the rotational power or torque to the screw device 381. The socket 382 may have a shape corresponding to the shaft 383.

The shaft 383 has a shape corresponding to the shape of the socket 382 and may be connected to the socket 382. As an example, the shaft 383 and the socket 382 may have the same polygonal shape. The shaft 383 may transmit the rotational power or torque to the socket 382. The shaft 383 may be connected to one end of the connecting frame 384.

The connecting frame 384 may connect the shaft 383 to the replacement robot 100. The connecting frame 384 may have a shape corresponding to the shape of the gripper mounted on the robot arm 102 of the replacement robot 100. The connecting frame 384 may be gripped by the gripper of the replacement robot 100 and may receive the rotational power or torque from the gripper.

According to some example embodiments, a replacement robot 100 may grip the connecting frame 384 and move the shaft 383 connected to the connecting frame 384 toward the socket 382 connected to the screw device 381. The replacement robot 100 may align the shaft 383 with the socket 382 and then connect the shaft 383 to the socket 382. The replacement robot 100 may then provide the rotational power or torque to the connecting frame 384. The rotational power provided to the connecting frame 384 may be transmitted to the screw device 381 through the shaft 383 and the socket 382, and the screw device 381 may perform the rotational motion. By the rotational motion of the screw device 381, the cabinet body 301 may be opened or closed.

FIG. 27 is a perspective view of a door handle 371 and a marker 372 according to some example embodiments.

Referring to FIG. 27, the cabinet device 300 may include the door handle 371 and the marker 372.

The door handle 371 may form a connection with the door gripper 150 of the replacement robot 100. The door handle 371 may include a groove having a shape corresponding to the equipment fastening unit 152 of the door gripper 150. The equipment fastening unit 152 may be inserted into the groove of the door handle 371 and may form a connection with the door handle 371.

According to some example embodiments, the door handle 371 may be disposed on the outer wall 301Ew of the cabinet body 301. The door handle 371 may protrude from the outer wall 301Ew of the cabinet body 301 in the outward direction of the chemical equipment EQ.

The marker 372 may be arranged adjacent to the door handle 371. The marker 372 may be identified by the external device (e.g., the replacement robot 100 and/or the return robot 200) and may provide information on the position of the door handle 371 with respect to the external device. As an example, the replacement robot 100 may identify the marker 372 through a camera mounted on the robot body 101 and may identify the position of the door handle 371 through the marker 372. For example, the marker 372 may be a bar code, a QR code, or the like.

Although FIG. 27 only shows that the marker 372 is disposed on the right side of the door handle 371, this is only an example. The marker 372 may be arranged at various positions, such as the bottom, the top, the left side of the door handle 371, or in any location that can be accessed by an external device (e.g., the replacement robot 100 and/or the return robot 200) to identify (or read) the marker 372.

As described above with reference to FIGS. 26 and 27, the cabinet device 300 may include the cabinet driving device 310c or the door handle 371, so that the replacement robot 100 may directly open the cabinet body 301.

As described above, the chemical container replacement system 1000 according to some example embodiments includes the replacement robot 100, the return robot 200, the cabinet device 300, the container port 400, and the server 500. Thus, the empty container EC stored in the chemical equipment EQ may be automatically (e.g., without user intervention) transferred to the outside of the FAB and the full container FC may be supplied into the chemical equipment EQ.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

What is claimed is:

1. A replacement robot comprising:
a robot body;
a robot arm on the robot body;
an equipment cap gripper on the robot arm and configured to open and close an equipment cap module connected to a chemical container, the chemical container being an empty container; and
a container table on the robot body, wherein the container table comprises,
a table body;
a first container case on the table body and configured to accommodate the empty container;
a second container case on the table body and configured to accommodate a full container; and
a case driving device configured to rotate the first container case toward the second container case.

2. The replacement robot of claim 1, wherein the case driving device is configured to rotate the first container case such that at least a part of an upper inlet of the empty container in the first container case overlaps with an upper inlet of the full container in the second container case in a vertical direction.

3. The replacement robot of claim 1, wherein
the first container case is at a higher vertical level than the second container case,
the case driving device is configured to rotate the first container case toward the second container case about a virtual axis passing through the empty container in a first horizontal direction,
the virtual axis is at a lower vertical level than a central axis of the empty container, and
the first horizontal direction is perpendicular to a second horizontal direction from a center of the first container case toward a center of the second container case.

4. The replacement robot of claim 1, wherein the case driving device comprises:
a first fixed joint fixedly between the first container case and the second container case;
a second fixed joint fixedly on the second container case, wherein the second fixed joint is configured to maintain the second container case stationary;
a first rotary joint fixed to an upper portion of the first container case and configured to rotate about the first fixed joint;
a second rotary joint fixed to a lower portion of the first container case and configured to rotate about the second fixed joint;
an input link connecting the first fixed joint to the first rotary joint;
a coupler connecting the first rotary joint to the second rotary joint; and
an output link connecting the second rotary joint to the second fixed joint.

5. The replacement robot of claim 1, further comprising a control unit configured to control the robot arm, the equipment cap gripper, and the container table,
wherein the equipment cap module comprises a cap connected to an upper inlet of the empty container and a tube connected to a bottom of the cap and inserted into an interior of the empty container,
the control unit is further configured to control the equipment cap gripper such that the equipment cap gripper separates the cap connected to the upper inlet of the empty container from the empty container and control the robot arm to lift the cap in a vertical direction while maintaining an alignment state of the tube and the upper inlet of the empty container, and
in the alignment state of the tube and the upper inlet of the empty container, a base end of the tube exposed above the empty container overlaps with the upper inlet of the empty container in the vertical direction.

6. The replacement robot of claim 5, wherein
the container table comprises at least one camera on the table body, and
the control unit is further configured to obtain, through the at least one camera, an alignment image of the tube and the empty container, identify, based on the alignment image, a position error between the tube and the upper inlet of the empty container, and control the robot arm to correct the position error.

7. The replacement robot of claim 6, wherein
the control unit is further configured to identify, based on the alignment image, a central axis of the tube and a central axis of the upper inlet of the empty container, and
a horizontal interval between the central axis of the tube and the central axis of said upper inlet is identified by the position error.

8. The replacement robot of claim 5, wherein the control unit is further configured to maintain the alignment state of the tube and the upper inlet of the empty container and control the case driving device and the robot arm to transfer the equipment cap module to the full container.

9. The replacement robot of claim 1, wherein the equipment cap gripper comprises:
two fingers for fixing both sides of the equipment cap module;
a finger driving device connected to the two fingers and configured to increase or decrease a horizontal interval between the two fingers;
a rotary motor configured to provide rotary power to the equipment cap module; and
a light sensor configured to sense a position of the equipment cap module.

10. The replacement robot of claim 1, wherein each of the first container case and the second container case comprises:
a case guide configured to support a lower portion of either the empty container or the full container accommodated therein;
a plurality of fixing plates configured to fix both sides of either the empty container or the full container accommodated therein;
a contact pad on an inner surface of each of the plurality of fixing plates and comprising a friction material; and
a container fixing device configured to drive the plurality of fixing plates to contact the contact pad with either the empty container or the full container in the case guide.

11. The replacement robot of claim 1, wherein each of the first container case and the second container case comprises:
a case guide configured to support a lower portion of either the empty container or the full container accommodated therein;
an L-shaped fixing structure in contact with a bottom surface and a side surface of either the empty container or the full container accommodated therein and configured to fix the empty container or the full container; and
a locking device connected to the case guide and configured to fix the L-shaped fixing structure.

12. The replacement robot of claim 11, wherein the L-shaped fixing structure further comprises a pin at an end of an L-shaped vertical part and connected to a top ring of either the empty container or the full container to support the top ring.

13. The replacement robot of claim 11, the L-shaped fixing structure comprises:
a spring at an L-shaped corner point and configured to operate between an open state and a fixed state; and
a hole at an end of an L-shaped horizontal part and configured to connect with the locking device.

14. A replacement robot comprising:
a robot body;
a communication interface configured to communicate with an external cabinet device;
a robot arm on the robot body; and
a container table on the robot body, wherein the container table comprises,
a table body;
a first container case on the table body and configured to accommodate an empty container;
a second container case on the table body and configured to accommodate a full container; and
a case driving device configured to rotate the first container case toward the second container case.

15. The replacement robot of claim 14, further comprising:
an equipment cap gripper on the robot arm and configured to open and close an equipment cap module connected to the empty container or the full container;
a container gripper on the robot arm and configured to grip the empty container or the full container; and
a control unit configured to control the robot arm, the equipment cap gripper, the container gripper, and the container table, wherein the control unit is further configured to,
transmit, through the communication interface, an open command to the external cabinet device;
control the container gripper and the robot arm to accommodate the empty container in the external cabinet device in the first container case in response to the external cabinet device being opened; and
control the equipment cap gripper and the robot arm to move the equipment cap module on the empty container accommodated in the first container case to the full container accommodated in the second container case.

16. The replacement robot of claim 15, wherein the control unit is further configured to control the equipment cap gripper and the robot arm to mount the equipment cap module onto the full container, and control the container gripper and the robot arm to load the full container accommodated in the second container case onto the external cabinet device.

17. The replacement robot of claim 16, wherein the control unit is further configured to transmit, through the communication interface, a close command to the external cabinet device in response to the full container being loaded to the external cabinet device, wherein the external cabinet device is automatically driven in response to the open command and the close command.

18. The replacement robot of claim 14, further comprising:
a door gripper on the robot arm and configured to open and close the external cabinet device, and
a marker configured to identify a location of the external cabinet device.

19. A replacement robot comprising:
a robot body;
a communication interface configured to communicate with an external device;
a traveling unit configured to drive the robot body;
a container table on the robot body; and
a control unit,
wherein the container table comprises a table body, a first container case on the table body and configured to accommodate an empty container, a second container case on the table body and configured to accommodate a full container, and a case driving device configured to rotate the first container case toward the second container case, and
wherein the control unit is configured to receive, via the communication interface, a chemical container replacement command, and control, based on the chemical container replacement command, the traveling unit to move the robot body toward a chemical equipment.

20. The replacement robot of claim 19, wherein the control unit is further configured to transmit an open command to the chemical equipment through the communication interface when the robot body is moved toward the chemical equipment, and transmit a close command to the chemical equipment through the communication interface when the empty container is replaced.
